(19) United States
(12) Patent Application Publication
(10) Pub. No.: US 2020/0143471 A1
(43) Pub. Date: May 7, 2020

(54) Decentralized Blockchain Oracle Price Discovery Platform with Bi-Directional Quotes

(71) Applicant: ShapeShift AG, Zug (CH)

(72) Inventors: Mark Jackson, Fort Collins, CO (US); Kent Barton, Zug (CH)

(21) Appl. No.: 16/676,385

(22) Filed: Nov. 6, 2019

Related U.S. Application Data
(60) Provisional application No. 62/756,570, filed on Nov. 6, 2018.

(51) Int. Cl. G06Q 40/04; G06Q 20/06; G06Q 20/36; G06Q 30/02; H04L 9/06

(52) U.S. Cl. CPC G06Q 40/04; G06Q 20/0658; H04L 9/0637; G06Q 30/0201; G06Q 20/3678

(57) ABSTRACT

A decentralized price discovery platform, with bi-directional quotes, is a market for market makers to place quotes attesting to the value of a condition occurring outside of a blockchain, and insuring the value of the condition against movement with a backing value of blockchain tokens. An aggregate consensus value is computed based on the aggregate of all active bi-directional quotes to yield an oracle value that can be used by other participants in the blockchain network for decentralized applications relying on the value of the condition occurring outside the blockchain. The aggregate consensus value is further used to adjust estimated premiums on active bi-directional quotes to fair values such that the aggregate consensus value should converge to the true value of the condition occurring outside the blockchain. Traders fill di-directional quotes to yield consensus trades, providing insurance against price movement, and causing the aggregate consensus value to converge on a true value.

### CROSS-REFERENCE TO RELATED APPLICATIONS

This application is a non-provisional application claiming priority benefit of U.S. Provisional Patent Application No. 62/756,570, entitled “Decentralized Blockchain Oracle Price Discovery Platform with Bi-Directional Quotes,” filed Nov. 6, 2018, and incorporated by reference herein.

### BACKGROUND OF THE INVENTION

Participants in a market (e.g., an asset exchange, market for goods, services, commodities, etc.) often have the desire to speculate, hedge, or insure against short-term price movements. Traditional bid/ask markets can, in some circumstances, provide the desired hedge, but suffer from several disadvantages, such as market abuse and manipulation (e.g., front-running), and limit orders may not be fairly priced, especially on low-liquidity markets with thin order books where available trades may “ping-pong” between bids and asks, thus presenting traders undesirable choices for insuring short term price movements of an underlying asset.

There is another issue regarding decentralized applications (dApps), running on blockchains that rely on an input of an extrinsic value corresponding to a “real-world” event that cannot be determined from a copy of the blockchain alone. An “oracle” is an entity that may provide the desired extrinsic value. Disadvantages of existing oracles include: disagreement over the correct extrinsic value (e.g., when a digital asset trades at different prices on different exchanges); writing to a blockchain can be costly, inducing the oracle to reduce its volume of extrinsic data points to save money, thus causing the reported value to become stale; the oracle may have an incentive to report a false value to profit from manipulating applications and markets relying thereon; the oracle may not be properly compensated for providing the real-world observation and recording the value, etc. If an oracle relies on prices of executed trades of assets or options, there is also a “ping-pong” problem, on low-liquidity markets where the last trade is not necessarily reflective of the real price of the asset if there is a large spread between bids and asks.

Accordingly, there are needs for: 1) a decentralized blockchain price discovery platform that is not susceptible to abuse and manipulations, thus allowing market participants to hedge or insure against short term price movements; and 2) a reliable and cost-effective oracle service for any dApp relying on a stream of extrinsic data, as determined by the decentralized blockchain price discovery platform.

### BRIEF DESCRIPTION OF THE SEVERAL VIEWS OF THE DRAWINGS

The accompanying figures, where like reference numerals refer to identical, or functionally similar, elements throughout the separate views, together with the detailed description below, are incorporated in, and form part of, the specification, and serve to further illustrate embodiments of concepts that include the claimed invention, and explain various principles and advantages of those embodiments.

FIG. 1 is a block diagram of a decentralized blockchain price discovery platform with bi-directional quotes and an aggregate consensus value oracle feed in accordance with some implementations.

FIG. 2 is a block diagram of bi-directional quotes and consensus trades in connection with a decentralized price discovery platform in accordance with some implementations.

FIG. 3 is a plot of an aggregate consensus value based on bi-directional quotes and a comparison of order book depth on a decentralized price discovery platform compared to conventional order books in accordance with some implementations.

FIG. 4 is a plot of a placing a bi-directional quote with a spot price above the single aggregate consensus price and a user interface element for the same on the decentralized price discovery platform in accordance with some implementations.

FIG. 5 is a plot of placing a consensus trade in a call direction of a quantity partially filling a single bi-directional quote and another plot of placing a consensus trade in a call direction in a quantity filling more than a single bi-directional quote.

FIG. 6 is a plot of placing a consensus trade in a put direction of a quantity partially filling a single bi-directional quote and another plot of placing a consensus trade in a put direction in a quantity filling more than a single bi-directional quote.

FIG. 7 is a block diagram of an example trader workflow on a decentralized price discovery platform in accordance with some implementations.

FIG. 8 is a flowchart of an example market maker workflow on a decentralized price discovery platform in accordance with some implementations.

FIG. 9 is a flowchart of an example trader workflow on a decentralized price discovery platform in accordance with some implementations.

FIG. 10 is a block diagram of components of a decentralize price discovery platform with inter-blockchain communications via bridge zones between independent price discovery platforms running on separate blockchains in accordance with some implementations.

FIG. 11 is a block diagram of components of a decentralized price discovery platform with pools of active and inactive bi-directional quote blockchain smart contracts and pools of active and inactive consensus trade smart contracts in accordance with some implementations.

FIG. 12 is a user interface diagram showing a trading history of bi-directional quotes and consensus trades on a decentralized price discovery platform in accordance with some implementations.

FIG. 13 is a user interface diagram showing an outcome of a settled consensus trade on a decentralized price discovery platform in accordance with some implementations.

FIG. 14 is a diagram of geographically limited order books on a decentralized price discovery platform in accordance with some implementations.

FIG. 15 is a block diagram of a trustless blockchain asset swap on a basket of cryptocurrencies managed according to a price feed provided by a decentralized price discovery platform in accordance with some implementations.

FIG. 16 is a flowchart of an example method of offering exposure to a condition occurring outside a blockchain secured by automatic payment of digital asset funds on a decentralized blockchain price discovery platform in accordance with some implementations.

FIG. 17 is a flowchart of an example method of securing automatic future blockchain funds transfer on a decentralized price discovery platform on a blockchain based on price movement of a digital asset in accordance with some implementations.

FIG. 18 is a flowchart of an example method of example computer program product instructions implementing a decentralized price discovery platform on a blockchain in accordance with some implementations.

FIG. 19 is a flowchart of an example method of triggering settlement of a bi-directional trade on a decentralized price discovery platform in accordance with some implementations.

FIG. 20 is an example system that may be useful in carrying out the implementations disclosed herein.

Skilled artisans will appreciate that elements in the figures are illustrated for simplicity and clarity and have not necessarily been drawn to scale. For example, the dimensions of some of the elements in the figures may be exaggerated, relative to other elements, to help to improve understanding of embodiments of the present invention.

The apparatus, and method components, have been represented, where appropriate, by conventional symbols in the drawings, showing only the details that are pertinent to understanding the embodiments of the present invention, so as not to obscure the disclosure with details that will be readily apparent to those of ordinary skill in the art having the benefit of the description herein.

### DETAILED DESCRIPTION OF THE INVENTION

A typical asset exchange (e.g., a stock exchange, a digital asset exchange, etc.) maintains order books to match buyers and sellers of the asset. One side of the order books are “asks”, representing prices and quantities of the asset offered for sale; the other side of the order books are “bids”, representing prices and quantities of the asset that buyers wish to purchase. Placing a bid or ask onto an order book is referred to herein as a limit order. Thus, there is usually a “spread” that can vary, depending on the liquidity of the market, between the lowest ask and highest bid.

When a bid or ask is accepted by a counterparty, it is referred to herein as a market order. A market order is a trade that will “fill” a limit order by removing some or all of the quantity of the limit order off the order books. The price of an asset on an exchange can be viewed as the price of the last filled order. But, depending on whether the order books contain more volume of limit orders at the same price as the last filled trade, it may not be true that an additional quantity of the asset can be bought or sold at the same price as the last trade. Especially on low liquidity markets, the latest price can ping-pong between the highest bid and the lowest ask, making the latest trade on the exchange a noisy signal representing the true value of the asset being exchanged.

Asset derivative exchanges may support a type of derivative called an option: an opportunity to buy or sell an underlying asset at a future time for an agreed upon price known as the strike price. Options quotes offered for sale may include an expiration time and date that are often standardized to facilitate liquidity. Or the options may be based on a rolling duration with respect to the time an option quote is filled by a purchaser, referred also, herein, as a trader. Examples of rolling durations, with respect to the time an option quote is filled, may be found in U.S. Pat. Nos. 7,856,395 and 8,229,840 to Jackson, et al., which are incorporated herein by reference. The seller of an option receives a premium from a buyer of the option at the time of purchase. Depending on the price of the underlying asset when the bidirectional trade expires, exercising the trade may have value to the purchaser or the trade may be worthless at expiration. Whether the option has value at expiration depends on the value of the underlying asset. The option may settle into the underlying asset itself (e.g., a “call” option to purchase an underlying asset, which would likely be exercised only if the strike price is a lower price than the current market price), or the option could be an index option, which are cash settled against a published index. A formula that takes into account the volatility of the underlying asset may be the basis for the premium price.

### Bi-Directional Quotes

A bi-directional quote, also referred to herein as a quote, is a quote on an underlying condition attesting to a value of the condition (e.g., the price of an asset, good, service, commodity, etc. at a given time). The quote is insured for accuracy, over an agreed-upon time frame, by a backing value (e.g., by a number of blockchain-based tokens). The bi-directional quote is placed by an entity referred to herein as a market maker, who offers the quote in return for a premium paid by an entity who purchases the quote, referred to herein as a trader. The quote is “bi-directional” in the sense that it simultaneously insures the accuracy of the quote with regard to movement of the underlying condition in both the up and down directions. A bi-directional quote is thus different from an option quote, which is either a put or a call; the bi-directional quote is simultaneously a put and a call, depending on the movement of an aggregate consensus value.

A bi-directional quote includes a spot value representing the value of a condition observed or perceived by the market maker who places the quote. The condition may include an event or condition extrinsic to a blockchain that the market maker can observe and/or perceive and determine a value associated therewith. Throughout this disclosure, the example of a digital asset trade is used as an example of an extrinsic event occurring outside a blockchain (e.g., what is the value of bitcoin priced in dollars, what is the exchange rate between Z-cash and Ether, etc.). But, any event that can be observed and represented numerically can be used. Examples of extrinsic events include, without limitation, the average price of rental housing in a geographical market, the value of a good, service, or commodity, demand for a good, service, or commodity, whether an event occurred or did not occur, and a likelihood that an event will occur, etc.

Another component of a bi-directional quote is a duration. The duration may be relative to the time the quote is filled to produce a consensus trade, such that the consensus trade expires after a fixed number of blocks have been added to a blockchain. In other implementations, traded quotes expire after an amount of time has elapsed since the quote filled (e.g., 48 hours after the quote was filled). Bi-directional quotes themselves need not expire and may sit on the order books indefinitely, until filled, or until cancelled.

The market maker attaches a backing value, dependent on the value of the real-world events at the time of the expiration, to a bi-directional quote, that is used to pay out to the trader. The amount of backing is an escrow deposit put up by the market maker to guarantee the contract can be fulfilled. Since the backing value is vulnerable to loss, if the spot price of the quote diverges from a consensus value (explained below) at the time of expiration, the backing value is indirectly related to the market maker's confidence in the accuracy of its observation of the extrinsic value. The backing thus determines the weight of the quote in the consensus value for the market. When the quote is settled, the backing value is apportioned between the trader and the market maker according to the value of the underlying asset and the spot price.

A bi-directional quote also includes an estimated premium that, in some implementations, indirectly determines the price paid by a trader who accepts the quote. The adjusted premium cost paid by a trader is a variable amount that depends partially on the estimated premium and partially on a consensus value of the underlying at the time of expiration. Inversely to backing value, a market maker is likely to ask a higher premium the less confident the market maker is in the accuracy of the spot value of the observation, and the more uncertain the market maker is regarding the volatility of the real-world observation over the duration period of the quote.

### Aggregate Consensus Value

Unlike a conventional options exchange, the strike price, and adjusted premium price, of a bi-directional quote are not fixed when the quote is placed onto the market by a market maker. Instead, the adjusted premium price depends on an aggregate consensus value at the time of purchase, and the strike price depends on the aggregate consensus value at the time of expiration of the bi-directional quote. The aggregate consensus value at a given time is based on an aggregate of all bi-directional quotes active at that time. The aggregate consensus value will thus change as quotes are added to, and removed from, the order books of the decentralized price discovery platform.

Various formulas may be used to determine an aggregate consensus value (since the example of digital asset prices is commonly used in this disclosure, the aggregate consensus value may also be referred to as an aggregate consensus price). In one implementation, the aggregate consensus value is equal to the sum of the spot prices of each individual quote multiplied by the quantity of each quote, divided by the total quantity of the aggregate of active bi-directional quotes. In this example, the quantity of a bi-directional quote is the backing value of the bi-directional quote divided by the quote's estimated premium, divided by an optional leverage factor.

The aggregate consensus price is, therefore, constantly changing as open quotes are added, removed, and/or modified by market makers to reflect ongoing observations of the extrinsic condition, and as traders fill open quotes from the aggregate of quotes by accepting the quotes and paying the market makers an associated premium. In one implementation, the aggregate consensus value of bi-directional quotes is computed according to the following formulas:

$$Aggregate consensus value of n quotes = \frac{{\sum }_{1}^{n} quote n spot * quote n qty}{{\sum }_{1}^{n} quote n qty} , \\ where Qty of a quote = \frac{backing value}{est . premium * leverage factor}$$

Although a bi-directional quote includes an estimated premium when a market maker places the quote on the price discovery platform, quotes are usually not traded at the estimated premium in implementations where the estimated premium is revised to an adjusted premium. Instead, the quoted premium is increased or decreased automatically based on how close the bi-directional quote's spot price is to the aggregate consensus value at the time a trader fills the quote in the chosen direction of the trade. Two example trades are illustrative. Example Trade #1: if a consensus trade is placed in the direction of a call against a quote, and the aggregate consensus price is higher than the spot price of the quote, then the adjusted premium is discounted from the estimated premium. Example Trade #2: on the other hand, if a consensus trade is placed in the direction of a put against the same quote, as in Example #1, then the adjusted premium is increased from the estimated premium by the same amount as the discount of Example #1.

Various methods may be used to price an adjusted premium. In some implementations, a formula such as the Black-Scholes option pricing formula may be used to adjust the estimated premium at the time of purchase of the consensus trade. The Black-Scholes formula provides a theoretical estimate of the price of a European-style option, but it can be computationally expensive, especially if executed in a blockchain environment. In other implementations, a simplified pricing formula may be used, such as a linear approximation (e.g., half the difference between the spot value of the quote and the aggregate consensus price). Appendix D is an illustration of a comparison of the linear approximation compared to the Black-Scholes formula for a call price vs. strike price and put price vs. strike price as the strike price moves away from the spot price. As illustrated in Appendix D, the linear approximation remains close to the value of the Black-Scholes model for strike prices near the spot price, and diverges as the strike price moves further away from the spot price.

Adjusting the estimated premium of a bi-directional quote, based on distance away from the aggregate consensus value, reduces the premium of the quote the farther the quote's spot is from the consensus spot, if the direction of the trade matches the delta between the aggregate consensus value and the spot price of the quote. As the aggregate consensus value moves farther away from the quote's spot, the adjusted premium of the quote will approach zero. As the adjusted premium approaches zero, traders interested in speculating on price movement will be motivated to trade cheaply priced (or, in the extreme case, free) quotes. This mechanism will naturally remove bi-directional quotes that are far from the consensus spot from the aggregate of active quotes.

### Settlement of a Consensus Trade

When a bi-directional quote, or a quantity of bi-directional quotes, has been filled, the result is referred to herein as a consensus trade. The market order from a trader who fills the bi-directional quote(s) will include a direction of the trade (e.g., call or put) and an adjusted premium paid to the market maker. The quote includes a backing value (e.g., blockchain tokens) that is held by the decentralized price discovery platform until expiration of the trade. When the trade expires, the backing value is apportioned between the market maker and the trader according to the aggregate consensus value at the time of expiration. The backing value thus serves as a type of insurance against price movement, purchased by the trader when the trader paid the adjusted premium to fill the quote. In some implementations, such as when the decentralized price discovery platform is on a blockchain, a settlement transaction may be sent by one of the two parties to the trade, or by a third party, to trigger the apportionment of the backing.

Once a critical mass of market participants is reached, the aggregate of quotes provides an accurate and reliable signal of the condition extrinsic to the blockchain that can be relied upon as a blockchain oracle by any interested party free of charge based on the concept of a so-called Shelling Point having been reached. Market participants are incentivized to identify and eliminate inaccurate data on the price discovery platform. Traders will be able to obtain very cheap, or free, trades on quotes that drift away from the aggregate consensus value, thus removing those quotes from the system, and pushing the aggregate consensus value towards the true value of the extrinsic condition. Market makers will be incentivized to modify quotes that drift from the true value because they stand to lose the backing value if the quote is filled by a trader, thus, also, pushing the aggregate consensus value towards the true value of the extrinsic condition. The incentives on the price discovery platform thus reward participants who supply accurate data, often the earlier the better in terms of financial reward, versus backing value risked by market makers. When there is a sufficient amount of market participation, the incentives provide negative and positive feedback that causes the aggregate consensus value to tend toward the true value of the condition extrinsic to the blockchain.

### Exemplary Aggregate Consensus Value and Exemplary Consensus Trade

Appendix A and Appendix B illustrate example bi-directional quotes and trades. Appendix A is a spreadsheet showing values for three bi-directional quotes, one trade filling all of Quote 1 and partially filling Quote 2, and a fourth bi-directional quote. Appendix B illustrates the same history of quotes and trades as Appendix A, but with formulas showing how the various values are calculated.

In Appendix A, the first quote is Quote 1 with a spot value of $275, a premium of $2, and a backing of 10 tokens. The quantity of Quote 1 is 0.5, where quantity is backing divided by premium, multiplied by a leverage factor of 10. After placing Quote 1, the aggregate consensus price is the same as the spot price of Quote 1 because there is only one quote on the order books. The adjusted premium in the call direction, or in the put direction, is equal to the estimated premium because the spot price of the quote is the same as the aggregate consensus value.

The next quote is Quote 2, with a higher spot price at $280, a smaller premium of $1 and a backing of 20 tokens. The quantity of Quote 2 is larger than Quote 1 (2.0) due to the larger backing and smaller estimated premium. Importantly, the placing of Quote 2 changes the adjusted premium that would be paid by a trader filling Quote 1 because Quote 2 moved the aggregate consensus price. The spot price of Quote 1 is now $4 below the aggregate consensus price, thus adjusting Quote 1's call premium to $0 and put premium to $4. Since Quote 1 is now a free call, it is likely highly attractive to bullish traders who believe the aggregate consensus price is likely to rise in the short term. The effect of adjusting the premium in this fashion is to incentivize the market maker, who placed Quote 1 to revise the quote, to move closer to the aggregate consensus if the market maker believes the aggregate consensus price has moved in the correct direction, or to leave the quote if the market maker believes the aggregate has moved away from the true value of the underlying since the put premium is now $4. In the example illustrated in Appendices A and B, the actual call premium price is adjusted to be the estimated premium minus half the difference between the quote's spot and the current aggregate consensus or zero, whichever is higher. Other premium adjustment mechanisms may be used to ensure fair premiums, such as the Black-Scholes formula.

Quote 3 has a spot price of $282, an estimated premium of $1.50, a backing of 5 tokens, and therefore a quantity of 0.33. The placing of Quote 3 moves the aggregate consensus up slightly and adjusts the call and put premium prices of the quotes on the order book as shown in column I.

The next change to the order book, in this example, is a trade. When placing a trade, the trader needs only to specify the direction of the trade and the quantity to be purchased. Trade 1 is a call for a quantity of 0.75. Since Quote 1 has a quantity of 0.5 available for a call premium of $0, this is the best call premium available to the trader, and Trade 1 fills all of Quote 1 first, thus removing 0.5 quantity from the order books. There is still 0.25 quantity remaining to fill with Trade 1, which is applied to the next best call premium price, Quote 2, at a price of $1.32. Since Quote 2 had a quantity of 2.0, the fill from Trade 1 reduces Quote 2's quantity to 1.75 and proportionally reduces Quote 2's available backing to 17.5. The trader who placed Trade 1 paid zero tokens to the market maker who placed Quote 1 and 0.33 tokens to the market maker who placed quote 2. Trade 1 also removed 12.5 tokens of backing from the order books to apportion later between the trader and the two market makers, depending on the difference between the strike price of the trade (the aggregate consensus at the time the trade is made) and the aggregate consensus price at the time of expiration.

Another quote, Quote 4, comes in higher than the previous quotes, and moves the aggregate consensus price up to $282.16. Next, Trade 1 expires, and settles based on a strike price of $279.35 against a spot price of $282.16. As shown in Appendix A, settlement of Trade 1 results in a disbursal of (rounded) 2.1 tokens to the trader, 8.6 tokens to the first market maker, and 1.8 tokens to the second market maker. Taking into account the adjusted premium paid, the trade was a profit of 1.77 tokens to the trader and losses of 1.4 and 0.37 tokens to the market makers, respectively. Appendix B is the same spreadsheet as Appendix A with formulas shown for calculating the various quantities.

The example of Appendices A and B shows that a bi-directional quote and trade on a price discovery platform offers improvements over prior options trading platforms. The trader was able to obtain a fairly priced call (partially free) to insure against upward price movement of the underlying asset. The market makers lost money because they insured the price against the direction of the eventual aggregate consensus. The trader was not forced to choose from among discrete strike prices, as would have been necessary with a conventional option trade. Instead, the trader was able to trade on the aggregate consensus price at the time he placed his trade and obtain an effective spot price of $279.35, even though no single quote had been placed at that spot price.

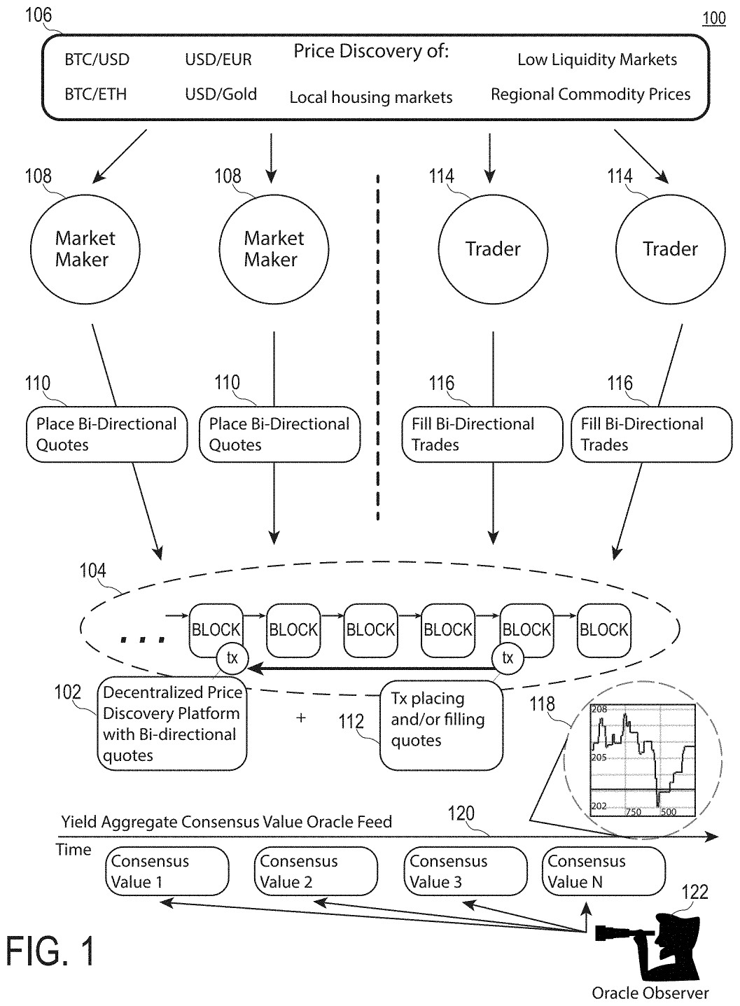

FIG. 1 is a block diagram 100 of a decentralized blockchain price discovery platform 102 with bi-directional quotes and a consensus value oracle feed 120 in accordance with some implementations. In the example illustrated in FIG. 1, price discovery of a variety of examples underlying assets 106 is made on the decentralized price discovery platform 102 running on blockchain 104. Market makers 108 and traders 114 observe market conditions of the underlying assets 106 independently, and place bi-directional quotes 110 and fill consensus trades 116 accordingly.

The decentralized price discovery platform 102 may include a collection of smart contracts on the blockchain 104. The bi-directional quotes 110, consensus trades 116, and settlements thereof may be made by broadcasting transactions to a network of the blockchain 104 for confirmation onto the chain such as transaction 112. The market participants need not participate directly in maintaining the ledger of the blockchain 104, but may rely on a network of nodes to promulgate and confirm their transactions relating to the price discovery platform 106.

Since any entity with a copy of the blockchain 104 can see the transactions confirmed thereon, an aggregate consensus history 118 is available to any member of the network of the blockchain 104. This aggregate consensus history can be viewed as an oracle feed 120, including a stream of updates to the aggregate consensus value that may be viewed by an oracle observer 122. Examples of oracle observer 122 include any dApp or user of a dApp that performs actions based on the value of one of the conditions 106.

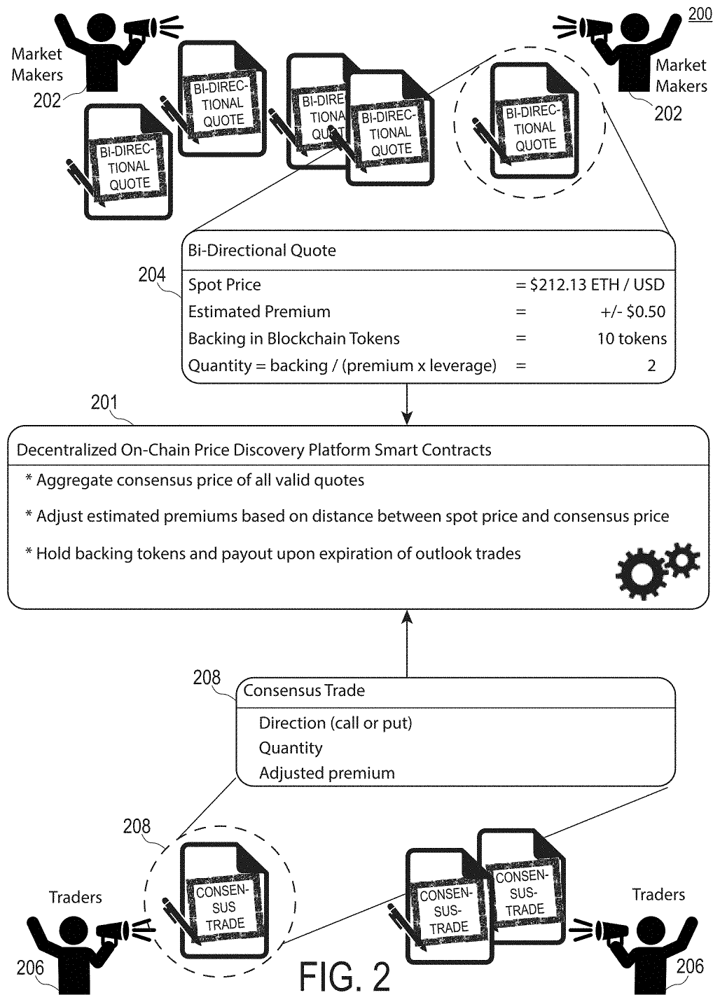

FIG. 2 is a block diagram 200 of bi-directional quotes 204 and consensus trades 208 in connection with a decentralized price discovery platform 201 in accordance with some implementations. Market makers 202 independently perceive a value of the underlying asset and construct bi-directional quotes 204 based thereon. The market makers 202 stand to profit if their quotes are in accordance with the consensus of the group of the market makers operating on the price discovery platform, and if the market makers have quoted an appropriate premium for the expected volatility and variability of the observed price over the time period of the duration of the quote. The bi-directional quotes 204 include a spot price, an estimated premium, a duration (e.g., time duration, elapsed blocks on a blockchain, etc.) a backing value (e.g., in blockchain tokens), an underlying condition (e.g., price of a cryptocurrency trade) and a quantity, which is a ratio of tokens to real-world units that make it convenient to trade on the platform 201 (e.g., tokens per dollar).

The decentralized price discovery platform 201, in the example illustrated in FIG. 2, includes components for performing various tasks of the system 200. These components may be implemented as one or more smart contracts on a blockchain or in a centralized system (e.g., a web server for presenting a user interface). In other implementations, the components may include logic included directly in the blockchain's block validators using application logic and a state machine custom for a particular chain. Components of the price discovery platform 201 may be split among a blockchain and other platforms. The components of the platform 201 include calculating an aggregate consensus price of all valid bi-directional quotes, adjusting estimated premiums to adjusted premiums of a quote based on other active quotes, holding or otherwise controlling backing tokens, and paying out tokens upon settlement of a consensus trade.

The system 200 further includes traders 206 placing filling bi-directional quotes with consensus trades 208. The consensus trades may only include a direction (e.g., call or put), and an underlying market (e.g., cryptocurrency trade), a quantity of the quotes to fill, and an adjusted premium. A duration of the trade is also used to calculate the expiration time, and is thus a parameter of the trade. The spot price of the consensus trade is the aggregate consensus price calculated based on the aggregate of bi-directional quotes active on the price discovery platform 201 at the time a consensus trade 208 is made. The adjusted premium may vary depending on whether the consensus trade 208 fills more than one bi-directional quote since different quotes may have different adjusted premiums, as explained herein with reference to Appendix A and Appendix B.

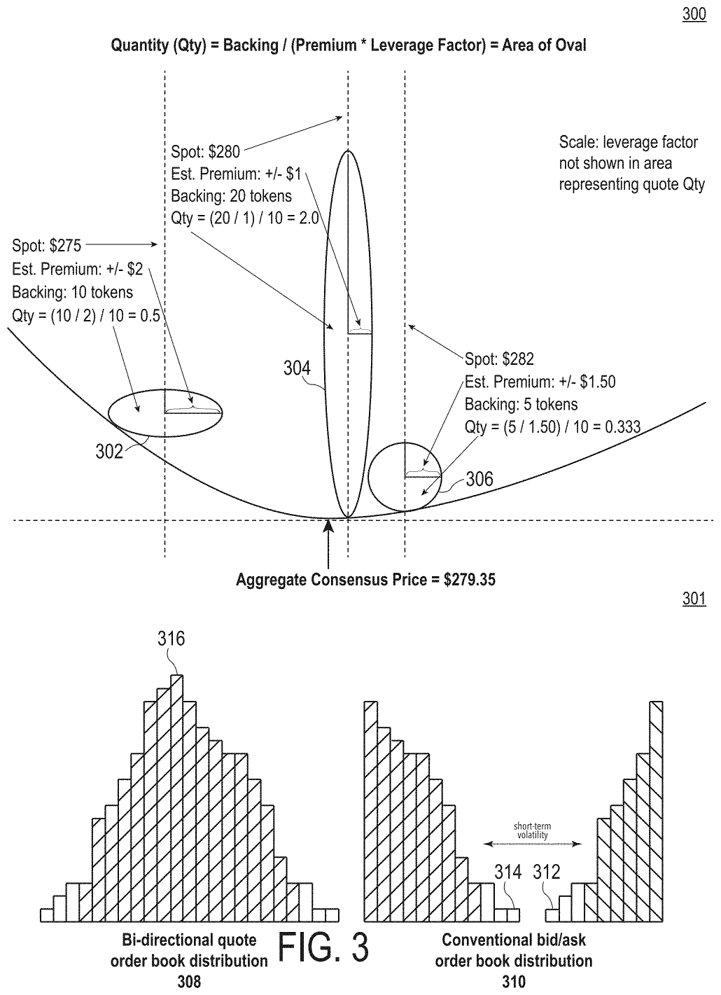

FIG. 3 is a plot 300 of an aggregate consensus value based on bi-directional quotes and a comparison 301 of order book depth on a decentralized price discovery platform compared to conventional order books in accordance with some implementations. The plot 300 illustrates the weight of three bi-directional quotes with respect to an aggregate consensus price using the same three quotes illustrated in Appendices A and B: Quote 1 (302), Quote 2 (304), and Quote 3 (306). The x-axis of plot 300 is in dollars, the surface area of the quote ovals indicates the quantity of each quote (note: plot 300 is not drawn to scale with respect to the leverage factor of 10). The horizontal radius of each quote shows the estimated premium, in both directions, from the spot price. It can be seen from plot 300 that a narrower estimated premium reduces the quantity of a quote, while an increased backing increases the quantity of the quote.

Plot 301 is a comparison of order book depth of bi-directional quotes on the decentralized price discovery platform 308 compared to order book depth on a conventional bid/ask exchange platform 310. On the bi-directional quote order book 308, the greatest quantity of quotes available for trades is concentrated in the middle, due to use of an aggregate consensus price as the effective spot price of the quotes. Adjusted premiums for quotes with spot prices farther away from the aggregate consensus price are adjusted downward and can approach zero, thus making these quotes attractive to traders interested in trading cheaply-priced quotes. The result is that the cheap quotes should be removed from the order books 308, resulting in the pyramid depth shape shown in plot 301.

The other half of plot 301 is a conventional bid/ask order book distribution 310. The shape of the conventional bid/ask distribution is different because the order books are arranged such that quotes are ordered from lowest price to highest. A trader wishing to fill orders on order books 310 will likely remove the cheapest bid/ask from the center of the order books, creating the opposing stairs shape.

There is likely to be a gap between the highest bid 314 and lowest ask 312 on order book distribution 310. On markets with low liquidity, the gap between 314 and 312 can grow quite large. Any oracle service relying on trades occurring on an exchange with order book distribution 310 runs the risk of short-term volatility due to a ping-pong effect where the latest filled trade can jump from one side of the order book to the other. Such jumping creates a noisy price signal and is susceptible to attackers exploiting this effect to capture higher premiums for trades based thereon. The single pyramid shape of the order books 308 eliminates the short-term volatility effect because of the more stable aggregate consensus price.

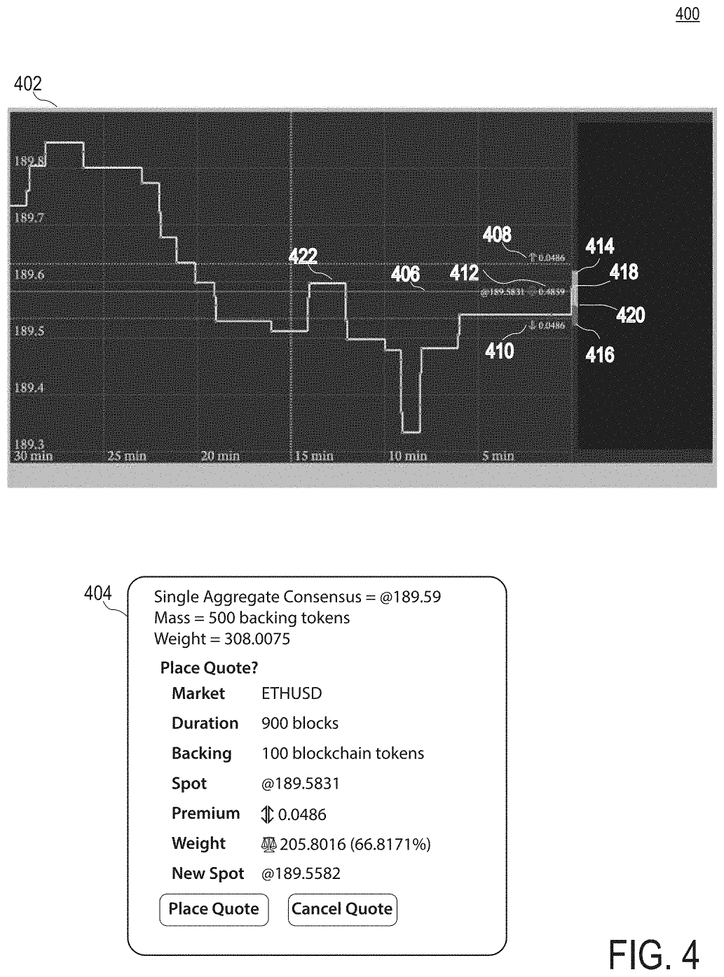

FIG. 4 is a plot 402 of a placing a bi-directional quote with a spot price above the single aggregate consensus price and a user interface element 404 for the same on the decentralized price discovery platform in accordance with some implementations. The plot 402 illustrates a single aggregate consensus price history with timeline along the x-axis. This example plot 402 shows a single aggregate price history 422 based on an aggregate of bi-directional quotes with expiration times of 900 blocks on a blockchain, which here is estimated by the vertical dashed line near the 15 minute mark. As bi-directional quotes are cancelled, modified, and/or filled and thus removed from the aggregate, the single aggregate consensus value shifts, depending on the changes made to the bi-directional quotes. A current single aggregate consensus value is shown at the point 418 based on a current aggregate of bi-directional quotes.

The plot 402 illustrates a potential placing of a bi-directional quote with a spot price at 189.5831, which is above the current single aggregate consensus price of 189.59; the potential new quote's spot price is shown on the plot 402 as the line 406 Near the line 406 is also shown the backing value of the potential quote, which may be entered for example in the user interface element 404. Lines representing the estimated premium of the potential new bi-directional quote are shown in the up direction and down direction at the lines 408 and 410, respectively. Plot 402 also illustrates the changes that will happen to the single aggregate consensus price and the adjusted premiums if the potential quote is actually placed. The market adjusted premium if the new quote is placed is shown in the up direction and the down direction as bars 414 and 416, respectively. The new consensus price if the potential bi-directional quote is placed is shown at the point 420, corresponding to a new price of 189.5582.

The user interface element 404 summarizes information shown in the plot 402 regarding the aggregate of bi-directional quotes, including a current single aggregate consensus value, the weight of the market, and current adjusted premiums in both up and down directions. Other elements of user interface 404 include the name of the market (e.g., the extrinsic measurement the market tracks, here the ethereum/USD currency market), the mass of the market, and the duration of the quotes. The user interface 404 also shows the parameters of the potential new bi-directional quote and the changes that will be effected if the quote is actually placed such as cost, the fraction of the total weight of the market represented by the bi-directional quote, and what would be the new single aggregate consensus price (e.g., the new spot price).

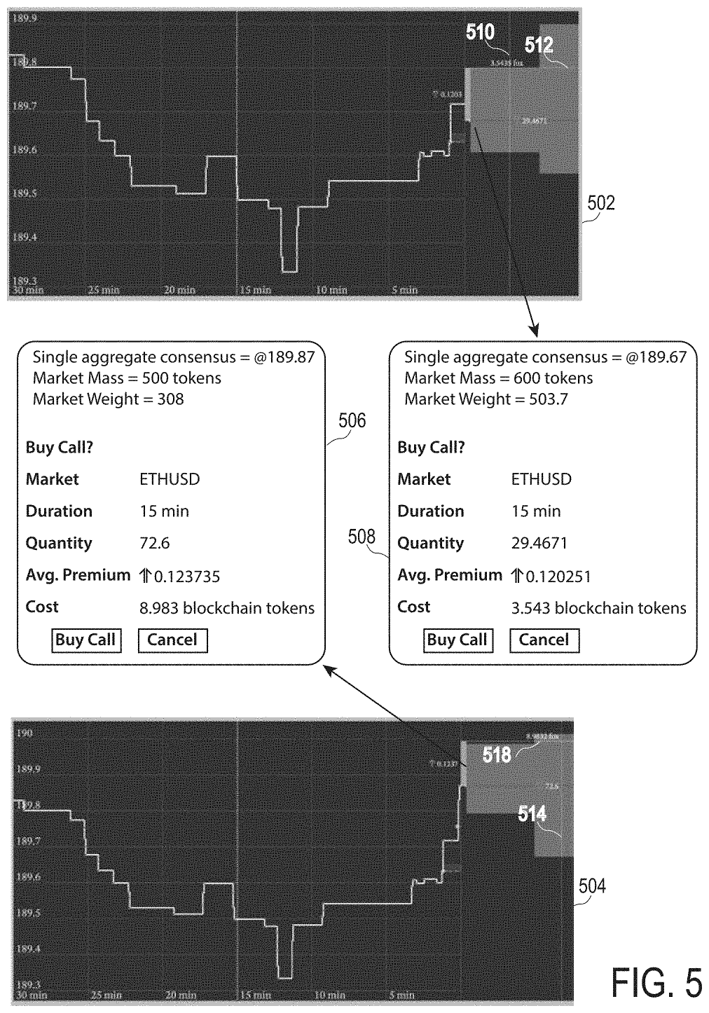

FIG. 5 is a plot 502 of placing a consensus trade in a call direction of a quantity partially filling a single bi-directional quote and another plot 504 of placing a consensus trade in a call direction in a quantity filling more than a single bi-directional quote. The parameters of the potential consensus trade in plot 502 are shown in user element 508 and the parameters of the potential consensus trade in plot 504 are shown in user element 506.

Starting with plot 502, the grey boxes illustrate bi-directional quotes in the aggregate of bi-directional quotes. The vertical line 510 illustrates a potential buy quantity of 29.4671, which carries an adjusted premium price of 3.5435 blockchain tokens, here referred to as fox tokens and represented by the horizontal line 512. The price is calculated by multiplying the market adjusted premium 0.1203 by the quantity to be purchased, 29.4671. The call is in the up direction as indicated by the horizontal line 512, which is above the current single aggregate consensus price. The user element 508 includes a buy call button to instruct a client to broadcast a transaction to a blockchain (e.g., smart contracts executing on a blockchain implementing the price discovery platform) to place the trade order.

Plot 504 shows a variation of a potential consensus trade where the quantity to be potentially purchased is greater than the best available bi-directional quote on the market. The amount to be purchased, a quantity of 72.6 represented by the vertical line 514 is larger than the available quantity of the best available bi-directional quote and thus the market adjusted premium is higher, at 0.1237, which is a blended rate resulting in a cost of 8.9832 blockchain backing tokens, represented at line 518. The user interface element 506 summarizes these parameters and the parameters relating to the aggregate of bi-directional quotes if the potential consensus trade is placed.

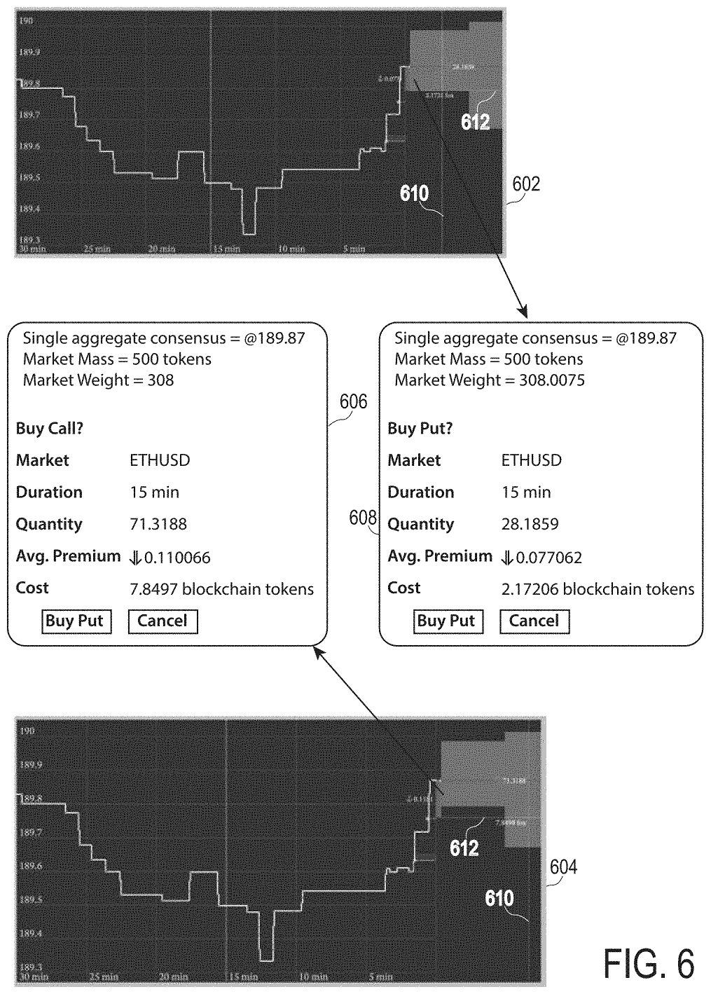

FIG. 6 is a plot 602 of placing a consensus trade in a put direction of a quantity partially filling a single bi-directional quote and another plot 604 of placing a consensus trade in a put direction in a quantity filling more than a single bi-directional quote. Plots 602 and 604 are similar to the plots illustrated in FIG. 5, except plots 602 and 604 illustrate a potential consensus trade of buying a put instead of buying a call. In plot 602, the quantity to be purchased is represented by vertical line 610 and the adjusted premium price is illustrated by horizontal line 612. Plot 604 illustrates a quantity to be purchased that is larger than the best available bi-directional quote at vertical line 610 and a blended adjusted premium represented by horizontal line 612. User interface elements 606 and 608 illustrate the parameters of the potential consensus trades and the effects on the aggregate of bi-directional quotes if the trades are placed.

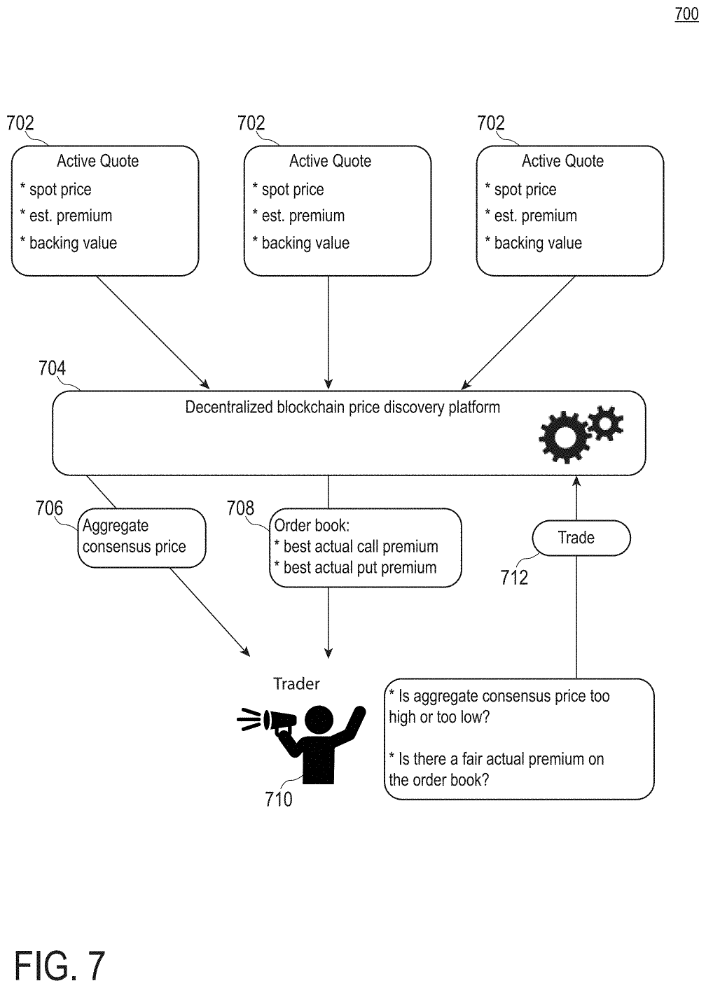

FIG. 7 is a block diagram 700 of a trader on a decentralized price discovery platform 704 in accordance with some implementations. Active bi-directional quotes 702 arrive at the decentralized blockchain price discovery platform 704 to generate an aggregate consensus price 706 and an order book 708 with a best call premium and a best put premium adjusted from the estimated premiums of the active quotes 702. The trader 710 compares the aggregate consensus price to a perceived price and evaluates the put/call premiums based on an expected volatility of the underlying asset. If the premiums are judged to be favorable based on the trader's opinion of what the aggregate consensus price should be, such as when the premiums approach zero for quotes far away from the aggregate consensus, the trader places trade 712 based thereon.

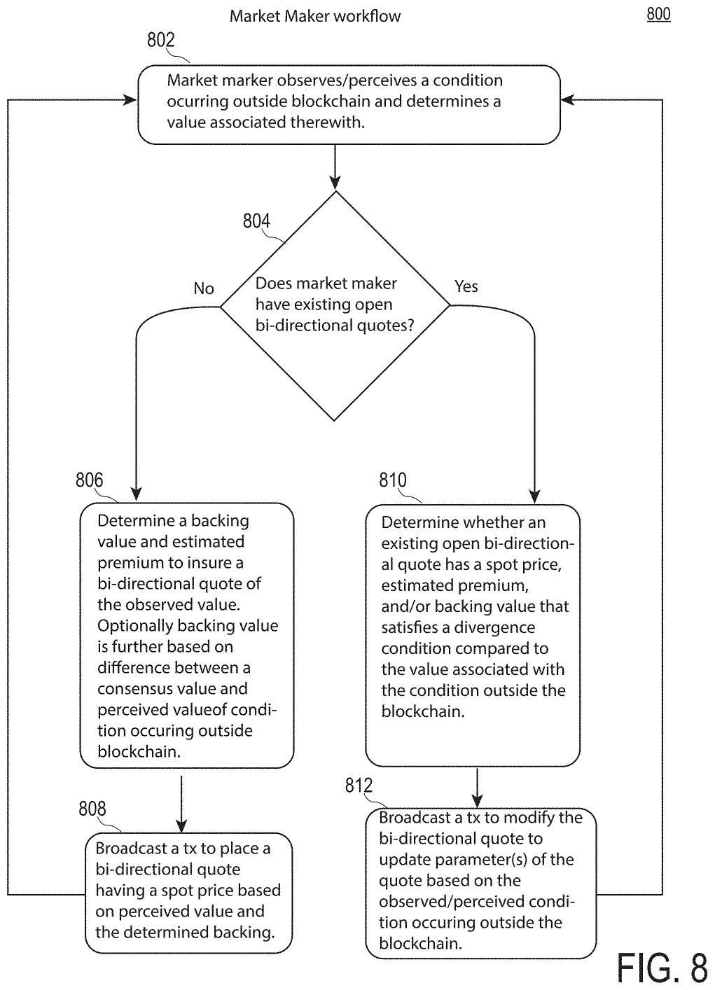

FIG. 8 is a flowchart of a market maker workflow 800 on a decentralized price discovery platform in accordance with some implementations. At 802 a market maker observes/perceives a condition occurring outside a blockchain and determines a condition associated therewith (e.g., the price of a cryptocurrency trade). At 804, execution of the workflow 800 depends on whether the market maker has existing quotes active on the price discovery platform. If not, the market maker determines a backing value to insure the quote based on the observed value. The market maker may perform step 806 “blind” in the sense that it is not necessary for the market maker to know an aggregate consensus value on the price discovery platform. The market maker could simply place the quote based on the observed value of the condition occurring outside the blockchain if the market maker has confidence that value is appropriate. On the other hand, knowing the current aggregate consensus value of the price discovery platform could help the market maker determine how much backing to put behind the quote. A wide spread between the aggregate consensus value and a spot price of a quote can cause the adjusted premium to be very low or near zero in one direction. The market maker may choose a backing accordingly based on this information. An operation 808 broadcasts a transaction placing the quote to a network of the blockchain and execution returns to operation 802.

If, at 804, the market maker does have existing quotes on the price discovery platform, execution proceeds to operation 810, which determines whether an existing open bi-directional quote has a spot price, estimated premium, and/or backing value that satisfies a divergence condition compared to the value associated with the condition outside the blockchain determined in operation 802. A divergence condition is satisfied when one or more of the aforementioned parameters is outside a range that the market maker deems likely to be profitable if a trader accepts the open quote. As the value associated with the condition occurring outside the blockchain changes over time, prior quotes placed by the market maker may become stale and expose the market maker to losses if the spot price of the quotes moves too far away from the value of the observed condition. The market maker may thus choose to modify existing quotes to “keep up” with the changing value of the condition outside the blockchain by modifying one or more parameters of the open bi-directional quote. On the other hand, making changes to existing quotes may incur a cost (e.g., gas on the Ethereum network) such that it may not be worth it to make a modification to an existing quote if the spot price of the existing quote is close enough to the observed price. A divergence condition is thus applied based on expected transaction costs of modification and other factors such as expected volatility and confidence in the accuracy of the observation of the condition outside the blockchain, and only if the divergence condition is satisfied will the market maker perform operation 810.

Operation 812 is a broadcasting operation of the transaction to modify parameter(s) of the existing quote to a network of the blockchain. The workflow 800 then returns to operation 802. In some situations, such as when the value of the underlying asset is in a state of rapid movement, the market maker may find that price adjustments of operation 812 are desired at a rapid rate, thus incurring high gas and/or transaction costs, and possibly the transactions of operation 812 cannot be confirmed fast enough by the network of the blockchain to keep up with the rapidly moving price of the underlying. In this scenario, the market maker may compensate by changing the estimated premium of the quote such that it covers the extra volatility introduced by the rapidly moving underlying price, thereby reducing gas and/or transaction cost expenditures and blockchain confirmation risk needed for rapid spot price adjustments of existing quotes. Changing the estimated premium of the quote is an important feature of the system described herein because it puts market makers in control of how often they wish to adjust spot prices. In other words, market makers can avoid repeated executions of operation 812 to update spot prices by placing quotes with larger estimated premiums if conditions on the blockchain or with the underlying condition are unfavorable.

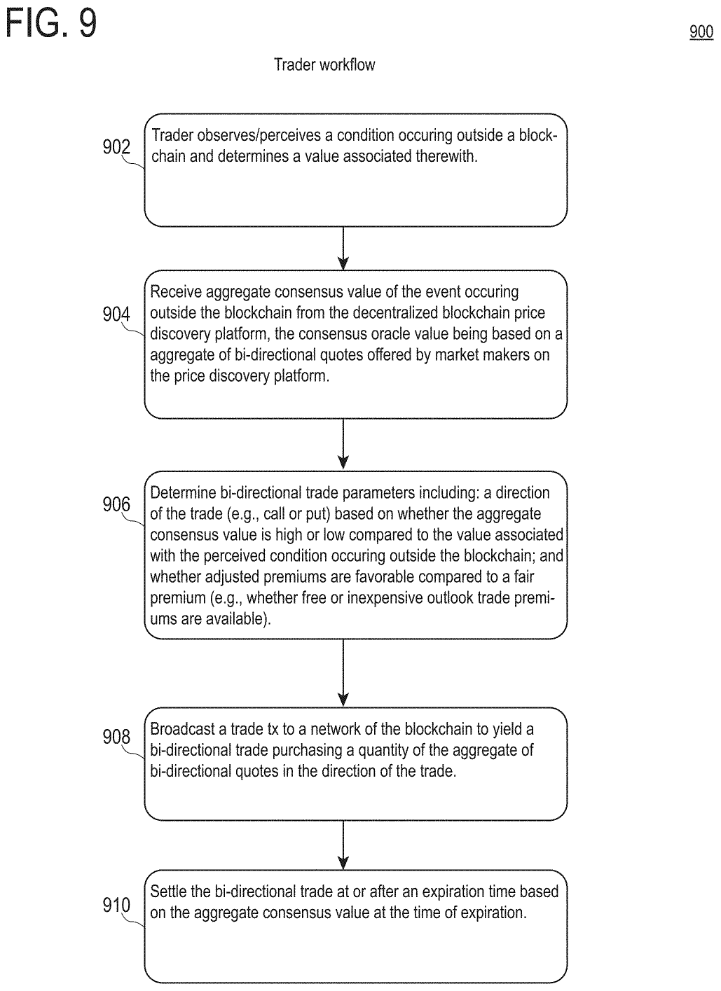

FIG. 9 is a flowchart of a trader workflow 900 on a decentralized price discovery platform in accordance with some implementations. At operation 902, a trader observes/perceives a condition occurring outside a blockchain and determines a value associated therewith (e.g., the price of a cryptocurrency). A receiving operation 904 receives an aggregate consensus value of the event occurring outside the blockchain from the decentralized price discovery platform, the consensus oracle value being based on an aggregate of bi-directional quotes offered by market makers on the price discovery platform.

A determining operation 906 determines consensus trade parameters including: 1) a direction of the trade (e.g., a put or a call) based on whether the aggregate consensus value is high or low compared to the value associated with the perceived condition occurring outside the blockchain from operation 902; and 2) whether adjusted premiums are favorable compared to a fair premium (e.g., whether free or inexpensive consensus trade premiums are available). A broadcasting operation 908 broadcasts a trade transaction to a network of the blockchain to yield a consensus trade purchasing a quantity of the aggregate of bi-directional quotes in the direction of the trade. The trade transaction may include a quantity of tokens to pay the market maker(s) the adjusted premium associated with the trade. Later, a settlement operation 910 settles the consensus trade at or after an expiration time based on the aggregate consensus value at the time of expiration of the trade. In implementations, operation 910 includes a separate blockchain transaction originating with one of the market participants (e.g., market maker, trader, price discovery platform, etc.) or from a third-party observer who monitors the pool of active trades for any trades that are expired, and who may collect a settlement reward for triggering the settlement thereof.

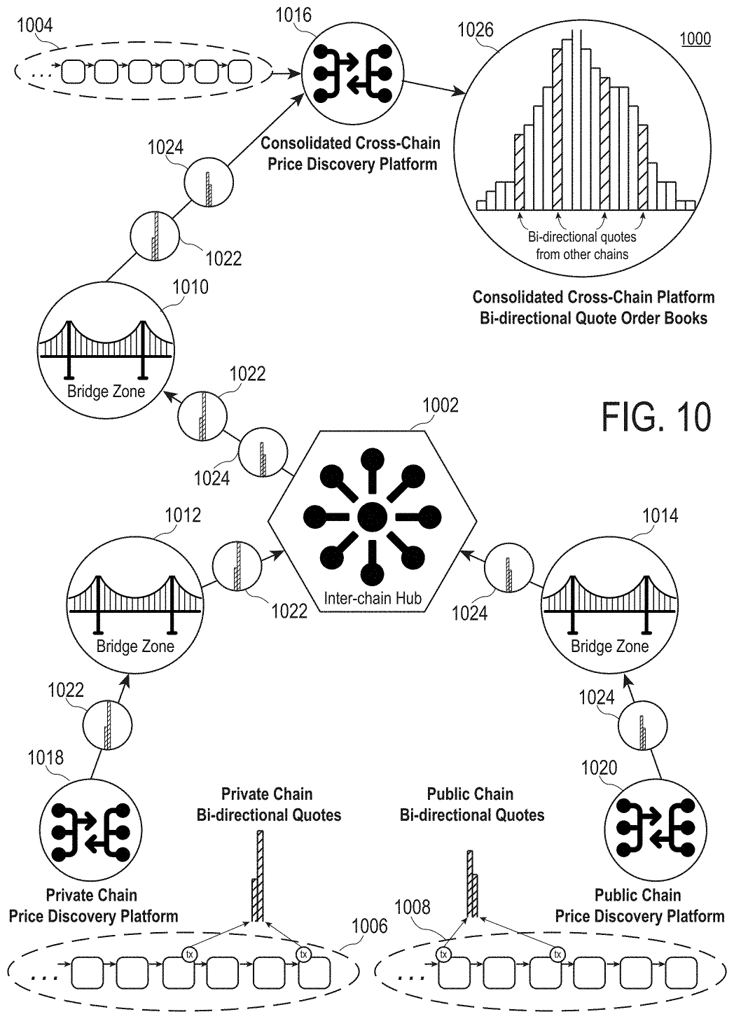

FIG. 10 is a block diagram 1000 of components of a decentralized price discovery platform with inter-blockchain communications via bridge zones between independent price discovery platforms running on separate blockchains in accordance with some implementations. An inter-chain hub 1002 connects separate and distinct blockchains via bridge zones 1010, 1012, and 1014, respectively. The inter-chain hub 1002 and the bridge zones 1010, 1012, and 1014 may, for example, communicate according to an IBC protocol (inter-chain communications) that allows information recorded on one of the blockchains to be readable on others of the connected chains without confirming a transaction to the reading chain. The hub and bridge architecture provides benefits such as the ability to store oracle data on a relatively cheaper chain and read that data or rely on it on a more expensive, and presumable more secure, chain without incurring the costs of confirming the oracle data on the more expensive chain. In the illustrated example, the blockchains 1004, 1006, and 1008 are running decentralized price discovery platforms 1016, 1018, and 1020, respectively.

In the diagram 1000, the hub and bridge architecture is used to merge multiple decentralized price discovery platforms with bi-directional quotes by simply sharing the weight of each marketplace with the other markets via the inter-chain protocol. Information regarding the aggregate of bi-directional quotes on a decentralized price discovery platform on one blockchain can be represented as simply floating-point values in the case of weighted average and total weight that can be quite easily and cheaply shared among the various blockchains. The hub and spoke architecture and sharing only the aggregate values is an improvement over other methods of sharing order books wherein every bid and ask would have to be communicated among the chains, or in a more expensive case, every bid and ask would have to be confirmed on-chain, which likely would be cost prohibitive on the more expensive chains. Since the more expensive chains are also likely to be more secure, then existing approaches to merging order books are likely not to work on the best and most desirable chains. Sharing every bid and ask also consumes much larger network bandwidth, which may impose slower communications times that may be unacceptable to participants in these markets.

Updating a shared decentralized price discovery platform with bi-directional quotes, on the other hand, consumes very little bandwidth. The decentralized price discovery platform 1018 running on blockchain 1006 has an aggregate of bi-directional quotes 1022. In the illustrated example, there are two bi-directional quotes, but much larger markets are possible. Via the bridge zones 1012 and 1010 and the inter-chain hub 1002, the aggregate 1022 is communicated to the decentralized price discovery platform 1016 running on blockchain 1004. Although in the figure the aggregate 1022 is illustrated as showing distinct orders, this is a conceptual depiction only. The individual orders and their associated parameters need not be communicated in their entirety to the decentralized price discovery platform 1016. Instead only the floating point aggregate values represented by the bi-directional quotes 1022, weighted average and total weight need be communicated.

Once the decentralized price discovery platform 1016 has received the communication of the aggregate values 1022 from the decentralized price discovery platform 1018, they may be merged into the aggregate 1026. Likewise, the decentralized price discovery platform 1020 communicates information describing the aggregate of its bi-directional quotes 1024 via the inter-chain hub 1002 and bridge zones 1014 and 1010 to the decentralized price discovery platform 1016 for merging into the order books 1026. In this way, various types of blockchains, illustrated here as private chain 1006 and public chain 1008 may be connected to share liquidity, thus improving the size and usefulness of the consolidated cross chain decentralized price discovery platform 1016.

To link distinct blockchains to merge liquidity as illustrated in FIG. 10, in some implementations, the various connected decentralized price discovery platforms share the same base token. Thus weighted average and total weight will be calculated according to the same units of account across the various markets. Sharing a blockchain token across blockchains may be accomplished in a number of ways, including locking tokens on one blockchain in order to mint them on another chain, then burning the tokens to remove the lock at a later time if desired (e.g., a cross-chain bridge, an atomic swap, a stateless swap, etc.).

One aspect of the decentralized price discovery platforms 1016, 1018, and 1020 is that they provide an improvement to the underlying blockchains in that they constitute an improved oracle. If the decentralized price discovery platforms have a majority of honest participants, then the single aggregate consensus price will tend toward the actual price. Thus, participants are economically incentivized to place bi-directional quotes and enter into consensus trades that will push the single aggregate consensus price towards the real-world price. Such a system does not rely on a single entity or group of entities that could provide incorrect or stale information to the oracle. Thus, any entity that wishes to participate in any blockchain application across any of the connected chains can rely on an essentially free oracle service since the history of the aggregate consensus price is recorded on the chain, where it is free to read.

Another way the oracle aspect disclosed herein is an improvement to blockchain oracle technology is that any party relying on the accuracy of the history of the single aggregate price and/or the current single aggregate price can calculate how expensive it would be for an attacker to abuse the single aggregate consensus price. Since the weighted average and the total weight of a decentralized price discovery platform market are observable, it is possible to calculate how expensive it would be to push the single aggregate consensus price away from the true price. This oracle thus provides adjustable security wherein any party relying on the veracity of the aggregate consensus price can at least determine whether it is likely an attack would be profitable. For example, if a decentralized finance smart contract containing a very large amount of digital assets were relying on a decentralized price discovery platform oracle price that could be attacked for only a small fraction of the funds available to be stolen from the decentralized finance contract, then users may choose not to participate with that decentralized finance contract because it could be profitable to attack the oracle and steal the funds. On the other hand, if the cost of attacking the decentralized price discovery platform oracle price is greater, or much greater, than the amount available to be stolen from the decentralized finance platform relying thereon, then the participants can have a much higher confidence that their funds will be safe from an attack and can choose to continue using the decentralized finance platform relying on the decentralized price discovery platform consensus price.

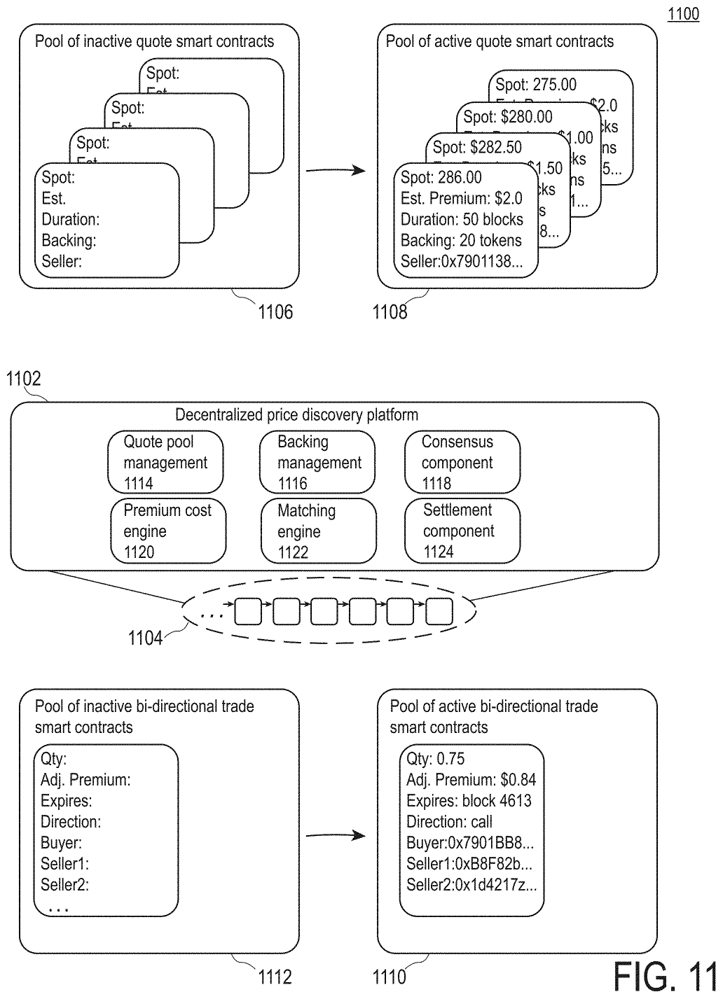

FIG. 11 is a block diagram 1100 of components of a decentralized price discovery platform 1102 including a pools smart contracts for management and settlement of bi-directional quotes and consensus trades in accordance with some implementations. The example illustrated in FIG. 11 is of a decentralized price discovery platform 1102 running on a blockchain 1104. The price discovery platform 1102 can itself include multiple smart contracts for performing the operations described herein that are interoperable and can be upgraded modularly.

The decentralized price discovery platform may also be implemented on systems that do not use smart contracts. Any Byzantine Fault Tolerant (BFT) system on a decentralized network with a distributed blockchain supporting custom application logic for dApps is suitable for running the decentralized price discovery platform. For example, networks with virtual machines (e.g., the Ethereum EVM), networks wherein application code is natively understood, at least a subset of validators on the network (e.g., Tendermint Cosmos, etc.) is suitable.

Often the deployment of smart contracts to a blockchain 1104 can incur transaction fees (e.g., gas on the Ethereum network) that may be substantial. The implementation of FIG. 11 avoids excessive gas fees due to the use of pooling smart contracts in pools 1106, 1108, 1110, and 1112. The pool can reuse and recycle smart contracts representing quotes and consensus trades.

In some implementations, an ordered list smart contract on the blockchain 1104 implements a circularly linked list that is efficient for certain on-chain operations including inserts, removals, and traversals of contracts representing quotes or consensus trades. The circular linked list may represent one or more of the pools 1106, 1108, 1110, and 1112 in that the circular linked list may grow or shrink depending on the number of elements of the respective pool. Structure and example Solidity source code of an exemplary circular linked list for execution on the Ethereum network is described in more detail in Appendix C attached hereto.

When a market maker wishes to place a new bi-directional quote on the price discovery platform 1102, the market maker may send a blockchain transaction to the platform 1102 (e.g., to the quote pool management smart contract 1114, also referred to herein as the bi-directional quote interface). The quote pool management smart contract 1114 can query the inactive quote pool 1106 to determine if there is an available inactive quote contract. If there is an available inactive quote contract, the quote pool management smart contract 1114 can assign the parameters of the market maker's quote to the available contract and transfer the contract to pool 1108 of active smart contracts. Transfer of an inactive quote smart contract to pool 1108 may include updating the internal state of the contract to reflect that the contract now represents an active quote and need not involve “moving” the contract on the blockchain 1104. If there is not an available inactive quote contract in the pool 1106, then the quote pool management smart contract 1114 can create a new quote smart contract. In one implementation, if there are no inactive quote smart contracts in the pool 1106, the market participants (e.g., market makers) can pay extra gas for a transaction on the blockchain 1104 to create a new smart contract, which will be initially added to the pool of active quotes 1108 and then recycled back to the pool of inactive contracts 1106 upon completion of the lifecycle of the quote contract. The quote pool management smart contracts 1114 component of the price discovery platform 1102 may include an internal state representing the order books of the price discovery platform 1102. Market participants (e.g., market makers and traders) can read the internal state of the quote pool management smart contracts 1114 on a copy of the blockchain 1104 to determine the terms on which quotes are available for trading on the platform.

Pool 1108 includes smart contracts representing active quotes on the decentralized price discovery platform 1102. Several components of the price discovery platform may rely on the smart contracts in the pool 1108. For example, backing management smart contract 1116 may hold a backing of tokens associated with each of the quote smart contracts in the pool 1108. In implementations, quotes may not be placed in pool 1108 until the backing has been received by the price discovery platform 1102 from the market maker placing the quote (e.g., blockchain tokens circulating on blockchain 1104). In other implementations, the active quote smart contracts in the pool 1108 may themselves hold the backing value represented the by quotes (e.g., a contract address of the quote contracts in the pool 1108 may be recipients of blockchain tokens representing the backing value and the quote contracts that are capable of paying out the backing value by apportioning the blockchain tokens between the market maker and trader according to the aggregate consensus value and other parameters at the time of expiration as described herein).

Other components of the price discovery platform 1102 also interact with the pool of active quote smart contracts 1108. The consensus component 1118, also referred to herein as the aggregate consensus component, computes the aggregate consensus value (e.g., price) based on the quantities (quantity itself being based on spot price, estimated premium, and backing of the individual quotes). The consensus component 1118 may confirm a record of the aggregate consensus value to the blockchain 1104 so that anyone with access to a copy of the blockchain (e.g., a network node, a block explorer, etc.) has a record of the consensus value (e.g., a price history of a cryptocurrency). The consensus component 1118 performs other functions including determining a single aggregate consensus price based on the spot price of each of the bi-directional quotes in the aggregate, weighted according to the estimated premium and according to the backing value of each bi-directional quote in the aggregate, recording the single aggregate consensus value to the blockchain, determining at least a call adjusted premium and a put adjusted premium of each bi-directional quote in the aggregate, the call adjusted premium and the put adjusted premium being based on the estimated premium and a difference between the spot price of each bi-directional quote and the single aggregate consensus value of each bi-directional quote in the aggregate of bi-directional quotes, recording the call adjusted premium and the put adjusted premium of each bi-directional quote in the aggregate of bi-directional quotes to the blockchain, and repeating the aforementioned operations upon each change to the aggregate of on-chain bi-directional quotes.

Premium cost engine 1120 smart contracts may compute the adjusted premiums of active quotes on the price discovery platform 1102. In implementations, a formula of either zero or the estimated premium minus half the difference between a quote's spot price and a current consensus price, whichever is higher, is used to adjust estimated premiums. In other implementations, adjusted premiums are priced by the premium cost engine 1120 according to other formulas such as the Black-Scholes formula. In some implementations, the premium cost engine 1120 includes an API interface to an off-chain service for computing adjusted premium values. Off-chain calculations of premiums may be desirable in cases where computation costs (e.g., gas costs on the Ethereum network) for processing to compute adjusted premium prices are expensive.

A matching engine 1122 may be used to match incoming trade orders with the appropriate active quotes (e.g., using the circular linked list smart contract data structure described in Appendix C). The circular linked list implementation provides a reduction in execution costs on the blockchain 1104 (e.g., gas costs) compared to a conventional exchange order matching engine, with which it may be too expensive to match trades on-chain.

As an example of order matching, a trade order may include only a quantity and a direction (as well as other parameters that may be implied, such as duration, trader address, etc.). In implementations, the trade should be filled against the best premium first and then applied to other quotes with increasing premium prices until the entire quantity of the trade has been filled. The quantity against which the trade is filled corresponds to specific quotes placed by market makers who put up backing value when they placed the quotes. The backing value corresponding to a filled quote should be removed from the order books by the matching engine 422 using the circular linked list, and thus changing the aggregate consensus value.

Backing management smart contracts 1116 may be used to store backing value (e.g., tokens on the blockchain 1104) included in new quotes when the quotes are placed on the price discovery platform 1102 by market makers. Alternatively, the quote smart contracts in the pool 1108 may hold the backing values directly. Since the backing value is to be apportioned between the market maker and trader when a trade settles, the backing management smart contracts 1116 may function as a wallet to hold the tokens and pay out the tokens accordingly to the market participants. Some market participants may choose to store backing tokens or other digital assets in the backing management smart contracts 1116, such as tokens to be used to make trades or place quotes. In other implementations, backing blockchain tokens are assigned to an address on the blockchain 1104 and transferred by assigning the blockchain tokens to the address according to a different type of token contract (e.g., an ERC-20/EIP-20 token contract on the Ethereum network or any existing or future-deployed type of standardized or custom token contract). As such, a blockchain transaction request to place a new quote, or make a trade, need not include tokens to pay the adjusted premium, or put up backing, if the address sending the request is associated with tokens already on deposit with the backing management smart contracts 1116.

A settlement component 1124 computes apportionment of the backing tokens between the market maker and the trader after a trade has expired. In some implementations, the smart contract of the settlement component 1124 are not capable of active monitoring of the pool of active trade smart contracts 1108 because the settlement engine 1124 will only run on the blockchain 1104 if a transaction paying gas costs is sent to it. Thus a settlement trigger transaction may be sent by a market participant, or even a third party, to the settlement components smart contracts 1124 to wake the code and perform the tasks described herein. An address on the blockchain 1104 from which the settlement trigger transaction is sent may be rewarded a settlement fee paid out of the backing value or as a separate fee to encourage participants and observers to monitor the pool of active trade smart contracts 1108 and send settlement transactions to ensure prompt and orderly flow of consensus trades on the price discovery platform 1102. Other fees may also be assessed to a settled trade such as a marketplace fee paid to operators of the price discovery platform 1102, and fees paid to relayers involved in reading the blockchain 1104 and determining which trades are expired, etc.

In some implementations, the blockchain 1104 may periodically cycle to a new chain. When a decentralized price discovery platform instance restarts on a new chain, governance parameters (e.g., platform commission amounts or percentages) can be adjusted without disrupting the market. Such adjustments are likely to be desired especially if a backing blockchain token changes in value. Other reasons for restarting a chain can include to synchronize chain operation to real-world accounting cycles, periodic update to the base software (e.g., the smart contracts), allowance for adjusting governance parameters, etc. If the decentralized price discovery platform 1102 shared liquidity with other decentralized price discovery platforms, such as under the hub and bridge architecture illustrated in FIG. 10, then restarting the blockchain 1104 may not cause disruption to market participants because they can rely on the other chains until the decentralized price discovery platform 1102 is back up, whether on the same chain 1104 or a newly instantiated chain.

In some implementations, a blockchain will have a halt block wherein the validators of the chain will no longer confirm transactions, even transactions that would have been valid before the halt, once the halt block has been reached. Examples of chains where a halt block is possible are chains with “fast finality.” If the blockchain 1104 has a halt block after which validators will no longer confirm transactions, then the settlement component 1124 may take measures to prepare the decentralized price discovery platform 1102 in advance of the halt block. Examples of preparation include freezing placement of new bi-directional quotes (e.g., bi-directional quotes that will expire, or are at risk of expiring after the halt block), perform settlement transactions such as apportioning backing tokens to the counterparties in advance of the halt block such that, if account balances are exported to the new chain after the halt, the account balances will represent correct amounts owned by the participants, communicate existing bi-directional quote aggregate information to other chains, etc.

The quote pool management smart contracts 1114 component of the price discovery platform 1102 may further manage recycling of active quote contracts in pool 1108 back to pool 1106 upon fulfillment by a trader. As such, the quote pool management smart contracts 1114 component of the price discovery platform 1102 may additionally recycle active consensus trade smart contracts between the pool 1110 and the pool 1112 depending on whether the smart contracts represent an active or inactive consensus trade.

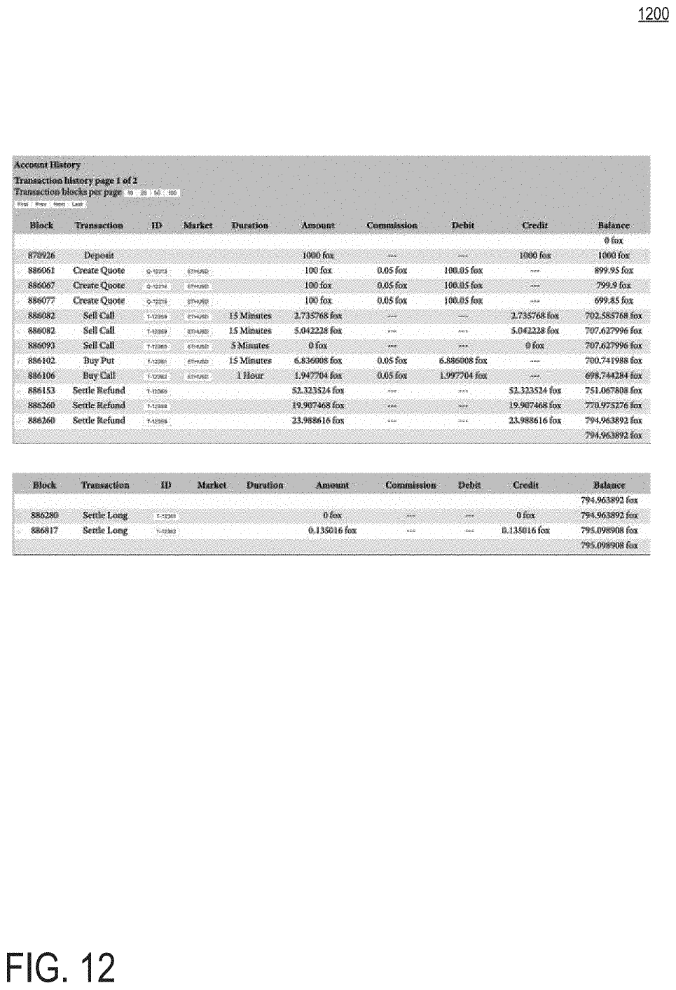

FIG. 12 is a user interface diagram 1200 showing a trading history of bi-directional quotes and consensus trades on a decentralized price discovery platform in accordance with some implementations. The example illustrated in FIG. 12 shows the history of a participant who first deposited 1000 backing blockchain tokens (referred to here as fox tokens) then proceeded to use the tokens for operations on the decentralized price discovery platform. In a first set of operations, the participant placed three new bi-directional quotes with 100 backing tokens each plus paid a commission fee of 0.05 backing tokens to the decentralized price discovery platform, such as to a deployer of the smart contracts of the decentralized price discovery platform or to a blockchain payment address associated with the operator of the decentralized price discovery platform. Next, the participant entered into five consensus trades, first selling three calls, buying a put, then buying a call, the purchase prices of which are shown in the table. Next, three refunds were received for the bi-directional quotes, all loses in this example wherein only a portion of the backing value was refunded to the participant. Lastly, two long positions of the consensus trades were settled, one which expired worthless and the last crediting the participant a small amount of backing token.

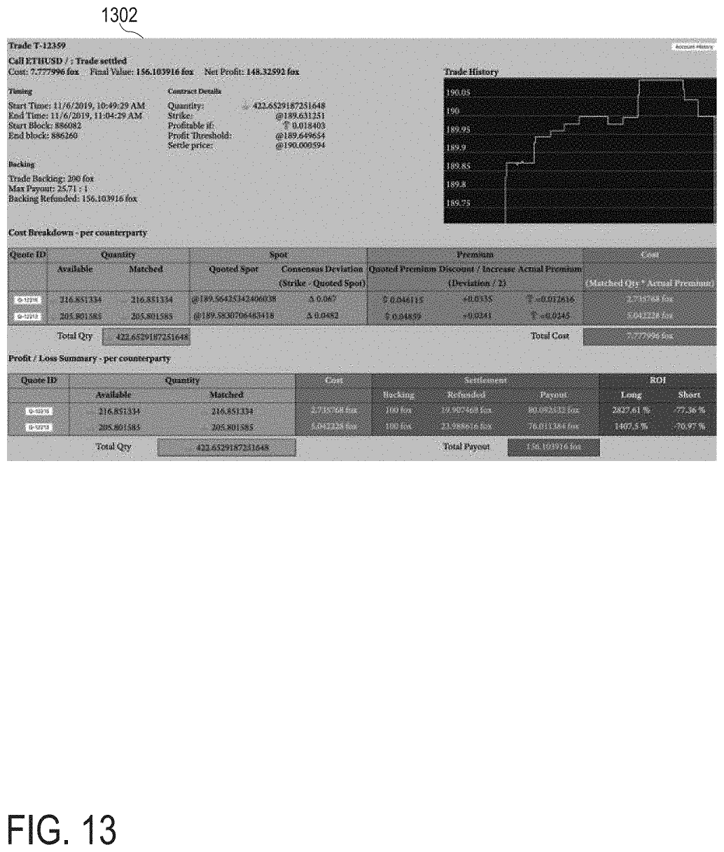

FIG. 13 is a user interface diagram 1302 showing an outcome of a settled consensus trade on a decentralized price discovery platform in accordance with some implementations. As shown in the user interface 1302, the trade cost 7.777996 backing blockchain tokens (fox) and ended with a much higher final value. The trade consisted of filling more than one bi-directional quote as shown in the cost breakdown per counterparty. The first of the two filled quotes cost approximately 2.7 backing blockchain tokens and the second of the two filled quotes cost the remainder of the price of the consensus trade, approximately 5.04 backing blockchain tokens.

The user interface 1302 further shows a profit and loss summary per counterparty to the consensus trade. Each of the filled bi-directional trades had a backing of 100 blockchain tokens, which were apportioned between the market maker who placed the bi-directional trade and the trader who bought the consensus trade based on a difference between the consensus value at the time of the trade expiration (the settle price) and the spot prices of the respective bi-directional trades.

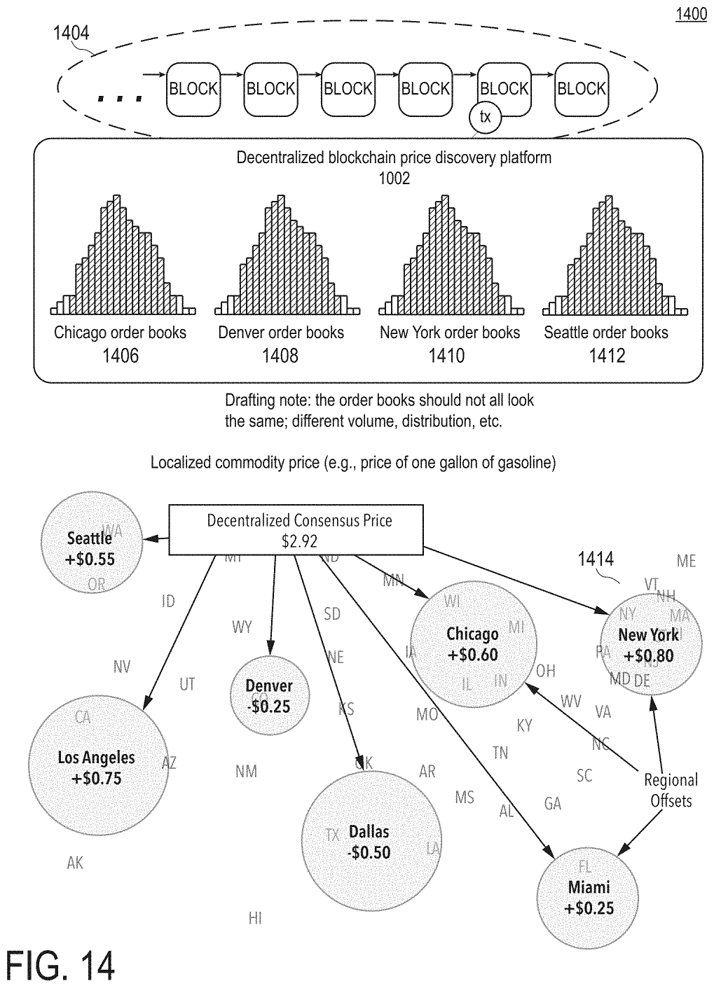

FIG. 14 is a diagram 1400 of geographically limited order books on a decentralized price discovery platform 1402 in accordance with some implementations. In the example illustrated in FIG. 14, a decentralized price discovery platform 1402 on a blockchain 1404 has a plurality of order books for bi-directional quotes, where each order book is geographically limited in scope. In this implementation, each set of order books is limited to a housing rental market in a specific metro area. The aggregate consensus price of each order book is an attestation to the average rental housing in the metro market, such as a price per square foot of rental space, insured by the market makers with a backing value. In some implementations, the geographically limited order books include aggregate consensus values that are relative prices to an overall consensus value. In other words, the consensus value of each geographically limited set of order books is a price difference (e.g., +$52.50 per square foot in the Chicago rental market) compared to the United States rental market as a whole).

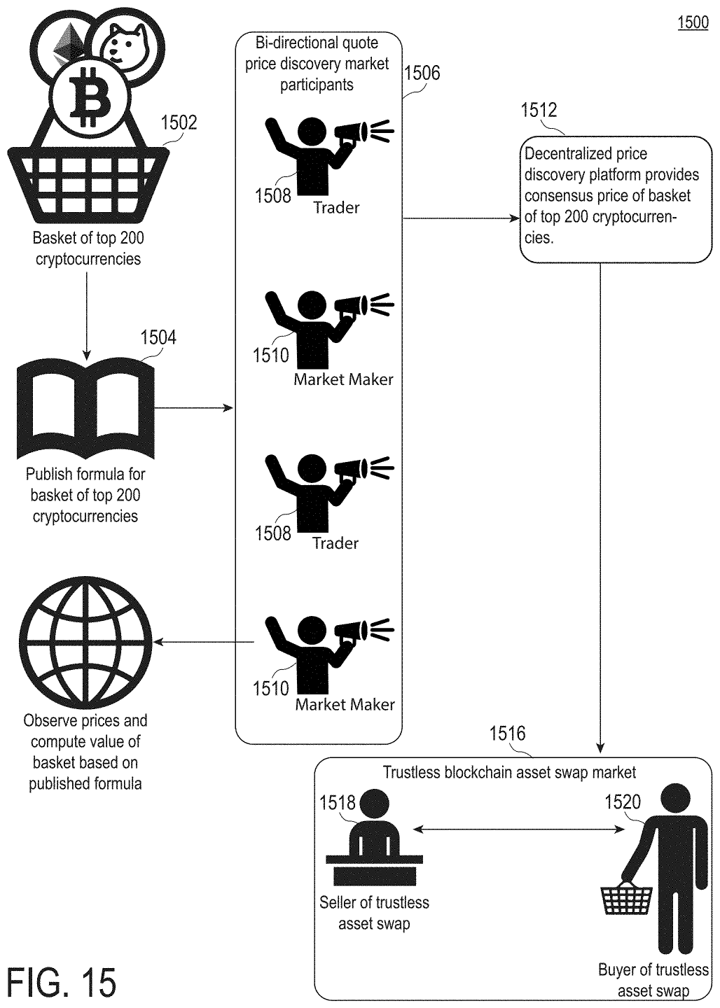

FIG. 15 is a block diagram 1500 of a trustless blockchain asset swap on a basket of cryptocurrencies managed according to a price feed provided by a decentralized price discovery platform in accordance with some implementations. Trustless blockchain asset swaps are disclosed in U.S. patent application Ser. Nos. 15/715,663, 15/715,680, 15/715,715, 15/715,746, and 15/715,770 the disclosures of which are hereby incorporated by reference. Briefly, a trustless blockchain asset swap is an agreement between a seller and a buyer to swap exposure to basket of assets (e.g., digital assets and/or cryptocurrencies), or any other condition occurring extrinsic to a blockchain wherein the buyer and seller each contribute an amount (e.g., an equal amount) of collateral in a base asset that is apportioned between the buyer and seller at a later time when the trustless blockchain asset swap is closed based on the value of the basket of assets.

For an example of a trustless blockchain asset swap consider the following: a seller 1518 offers exposure to a composite of the top 200 cryptocurrencies (e.g., equally weighted, weighted by market cap, weighted by volume, etc.) to a buyer 1520. Both the buyer 1520 and the seller 1518 contribute a base digital asset as collateral (e.g., ether on the Ethereum network) to a smart contract that holds the collateral and receives a price feed of the value of the basket of digital assets from an oracle. When one of the two parties chooses to close the trustless blockchain asset swap, the collateral is paid out according to the value of the basket, as reported by the oracle. For example, if the two parties each contribute 10 ETH as collateral, when the trustless blockchain asset swap is opened, and the value of the basket of digital assets rises 50% between the time the swap is opened and closed, then the smart contract will pay out 15 ETH to the buyer 1520 and 5 ETH to the seller 1518 upon closing of the swap.

For a trustless blockchain asset swap to be effective, the smart contract must have a reliable oracle feed (e.g., a price feed) representing the value of the digital assets in the swap. The system 1500 provides such an oracle feed to a trustless blockchain asset swap marketplace 1516. In the example illustrated in FIG. 11, a publisher 1504 publishes a formula for a basket of the top 200 cryptocurrencies. The formula may include which currencies are considered to be on the top 200 list and/or whether those currencies are weighted (e.g., according to market capitalization, volume, volatility, etc.). The example of the top 200 cryptocurrencies is merely illustrative; any index of assets, securities, services, goods, commodities may also be used.

When the publisher 1504 publishes the formula for the top 200 cryptocurrencies, a marketplace of market makers and traders on a decentralized price discovery platform 1506 make market observations regarding the prices of the cryptocurrencies in the basket 1502. The market makers and traders place and trade bi-directional quotes on the price discovery platform 1506, as described herein, and the platform provides an oracle price feed 1512 to the trustless blockchain asset swap market 1516. Buyers 1520 and sellers 1518 on the swap market 1516 can trade their swaps based on the oracle price feed 1512. In some implementations, the publisher 1504 is the seller 1518 who determines the contents of the basket of digital assets and offers exposure to those assets via the trustless swap. The seller 1518 may further hedge its exposure to the underlying basket of assets 1502, such that the seller 1518 maintains a neutral risk position with respect to the basket of assets 1502.

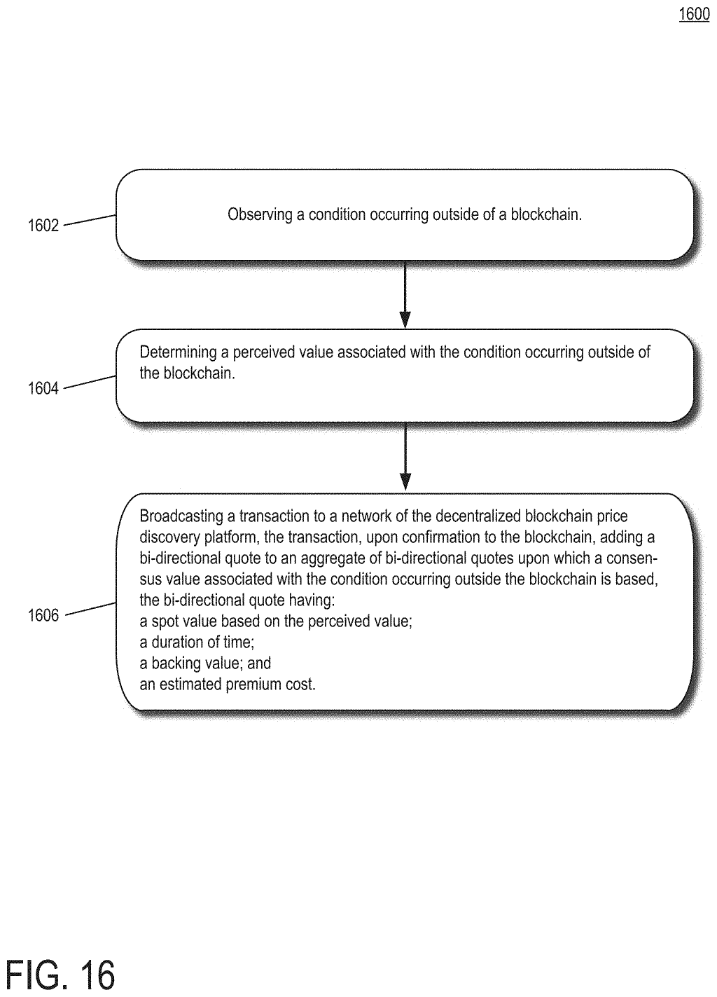

FIG. 16 is a flowchart of an example method of offering exposure to a condition occurring outside a blockchain secured by automatic payment of digital asset funds on a decentralized blockchain price discovery platform in accordance with some implementations. An observing operation 1602 observes a condition occurring outside of a blockchain (e.g., cryptocurrency trade, price of goods, services, commodity, asset(s), etc.). A determining operation 1604 determines a perceived value associated with the condition occurring outside the blockchain. The perceived value may be determined based on more than one data point regarding the condition (e.g., if a digital asset is trading for different prices at different exchanges at the same time, if the condition is an average rent price based on many real estate listings, etc.). A broadcasting operation 1606 broadcasts a transaction to a network of the decentralized blockchain price discovery platform, the transaction, upon confirmation to the blockchain, adding a bi-directional quote to an aggregate of bi-directional quotes upon which an aggregate consensus value associated with the condition occurring outside the blockchain is based, the bi-directional quote having: a spot value based on the perceived value, a duration of time, a backing value, and an estimated premium cost.

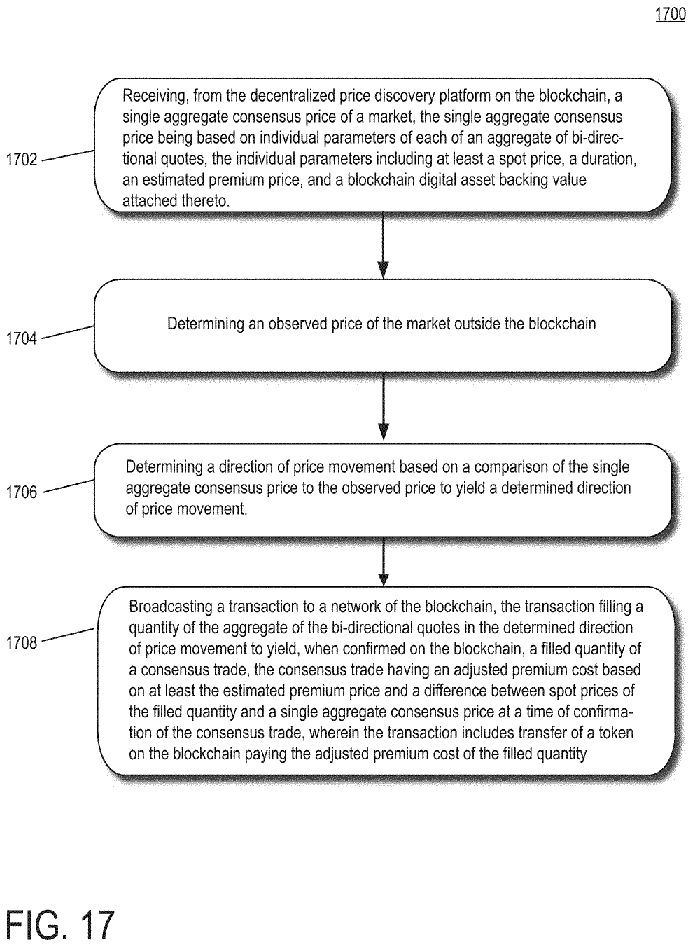

FIG. 17 is a flowchart of an example method of securing automatic future blockchain funds transfer on a decentralized price discovery platform on a blockchain based on price movement of a digital asset in accordance with some implementations. A receiving operation 1702 receives, from the decentralized price discovery platform on the blockchain, a single aggregate consensus price of a market, the single aggregate consensus price being based on individual parameters of each of an aggregate of bi-directional quotes, the individual parameters including at least a spot price, a duration, an estimated premium price, and a blockchain digital asset backing value attached thereto. A determining operation 1704 determines an observed price of the market outside the blockchain. A determining operation 1706 determines a direction of price movement based on a comparison of the single aggregate consensus price to the observed price to yield a determined direction of price movement. A broadcasting operation 1708 broadcasts a transaction to a network of the blockchain, the transaction filling a quantity of the aggregate of the bi-directional quotes in the determined direction of price movement to yield, when confirmed on the blockchain, a filled quantity of a consensus trade, the consensus trade having an adjusted premium cost based on at least the estimated premium price and a difference between spot prices of the filled quantity and a single aggregate consensus price at a time of confirmation of the consensus trade, wherein the transaction includes transfer of a token on the blockchain paying the adjusted premium cost of the filled quantity

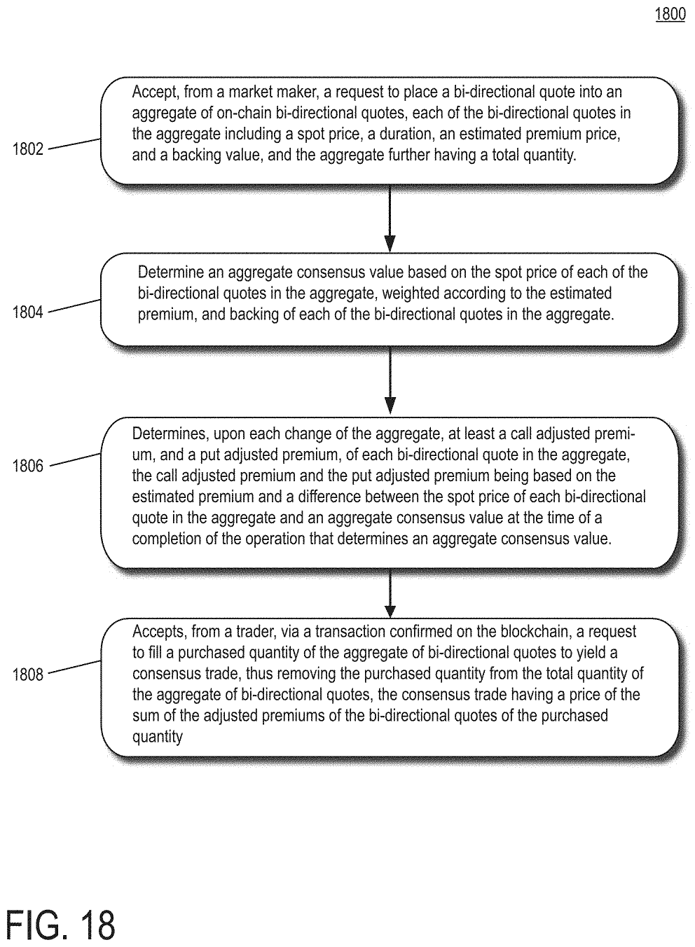

FIG. 18 is a flowchart of an example computer program product instructions implementing a decentralized price discovery platform on a blockchain in accordance with some implementations. The instructions may include a smart contract or set of smart contracts recorded on a blockchain by being confirmed to the blockchain according to consensus rules.

The instructions include an accepting operation 1802 accepts, from a market maker, a request to place a bi-directional quote into an aggregate of on-chain bi-directional quotes, each of the bi-directional quotes in the aggregate including a spot price, a duration, an estimated premium price, and a backing value, and the aggregate further having a total quantity. A determining operation 1804 determines an aggregate consensus value based on the spot price of each of the bi-directional quotes in the aggregate, weighted according to the estimated premium, and backing of each of the bi-directional quotes in the aggregate. A determining operation 1806 determines, upon each change of the aggregate, at least a call adjusted premium, and a put adjusted premium, of each bi-directional quote in the aggregate, the call adjusted premium and the put adjusted premium being based on the estimated premium and a difference between the spot price of each bi-directional quote in the aggregate and an aggregate consensus value at the time of a completion of the operation that determines an aggregate consensus value. And an accepting operation 1808 accepts, from a trader, via a transaction confirmed on the blockchain, a request to fill a purchased quantity of the aggregate of bi-directional quotes to yield a consensus trade, thus removing the purchased quantity from the total quantity of the aggregate of bi-directional quotes, the consensus trade having a price of the sum of the adjusted premiums of the bi-directional quotes of the purchased quantity.

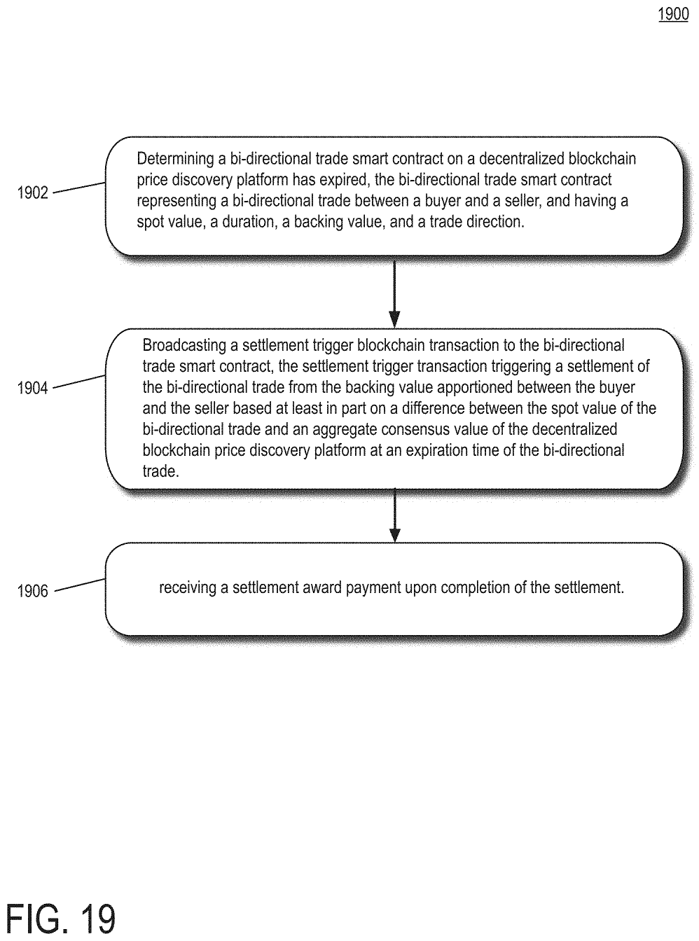

FIG. 19 is a flowchart of an example method 1900 of triggering settlement of a trade on a decentralized blockchain price discovery platform in accordance with some implementations. A determining operation 1902 determines if a consensus trade smart contract on a decentralized blockchain price discovery platform has expired, the consensus trade smart contract representing a consensus trade between a buyer and a seller, and having a spot value, a duration, a backing value, and a trade direction. A broadcasting operation 1904 broadcasts a settlement trigger blockchain transaction to the consensus trade smart contract, the settlement trigger transaction triggering a settlement of the consensus trade from the backing value apportioned between the buyer and the seller based, at least in part, on a difference between the spot value of the consensus trade and an aggregate consensus value of the decentralized blockchain price discovery platform at an expiration time of the consensus trade. A receiving operation 1906 receives a settlement award payment upon completion of the settlement.

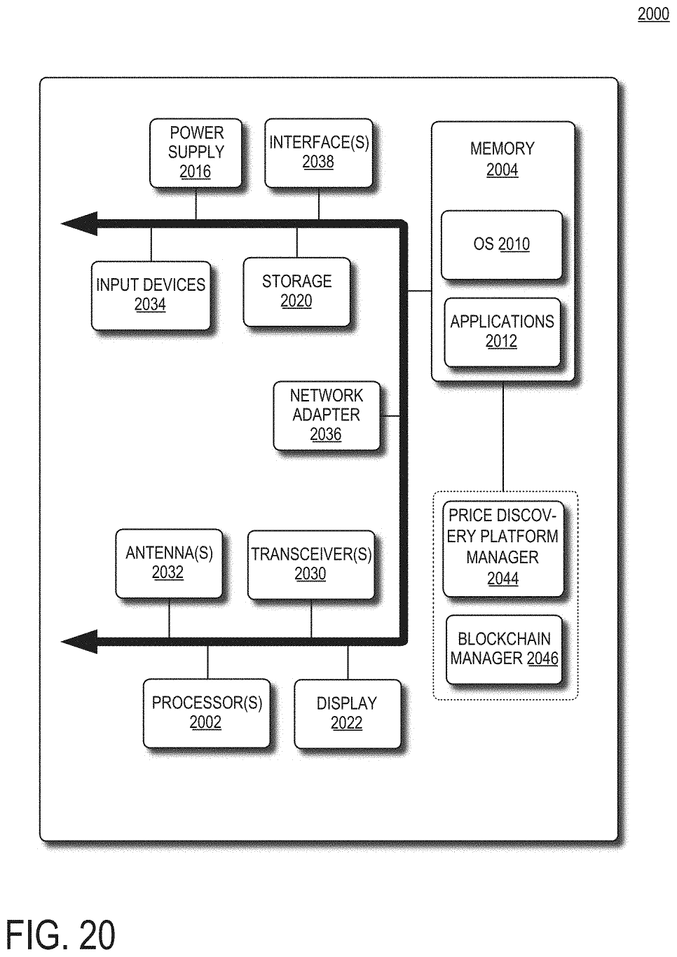

FIG. 20 is a diagram of a system 2000 that may be useful for implementing a trusted blockchain oracle. FIG. 20 illustrates an example system (labeled as a processing system 2000) that may be useful in implementing the described technology. The processing system 2000 may be a client device, such as a smart device, connected device, Internet of Things (IoT) device, laptop, mobile device, desktop, tablet, or a server/cloud device. The processing system 2000 includes one or more processor(s) 2002, and a memory 2004. The memory 2004 generally includes both volatile memory (e.g., RAM) and non-volatile memory (e.g., flash memory). An operating system 2010 resided in the memory 2004 and is executed by the processor 2002.

One or more application programs 2012 modules or segments, such as price discovery platform manager 2044 and blockchain manager 2046 are loaded in the memory 2004 and/or storage 2020 and executed by the processor 2002. In some implementations, the price discovery platform manager 2044 is stored in read-only memory (ROM) 2014 or write once, read many (WORM) memory. Data such as extrinsic event data sources may be stored in the memory 2004 or storage 2020 and may be retrievable by the processor 2002 for use by price discovery platform manager 2044 and the blockchain manager 2046, etc. The storage 2020 may be local to the processing system 2000 or may be remote, and communicatively connected to, the processing system 2000, and may include another server. The storage 2020 may store resources that are requestable by client devices (not shown). The storage 2020 may include secure storage, such as one or more platform configuration registers (PCR) managed by one or more trusted platform modules (TPMs), which may be implemented in a chip, or by the trusted execution environment (TEE).

The processing system 2000 includes a power supply 2016, which is powered by one or more batteries, or other power sources, and which provides power to other components of the processing system 2000. The power supply 2016 may also be connected to an external power source that overrides or recharges the built-in batteries or other power sources.

The processing system 2000 may include one or more communication transceivers 2030 which may be connected to one or more antenna(s) 2032 to provide network connectivity (e.g., mobile phone network, Wi-Fi®, Bluetooth®, etc.) to one or more other servers and/or client devices (e.g., mobile devices, desktop computers, or laptop computers). The processing system 2000 may further include a network adapter 2036, which is a type of communication device. The processing system 2000 may use the network adapter 2036 and any other types of communication devices for establishing connections over a wide-area network (WAN) or local area network (LAN). It should be appreciated that the network connections shown are exemplary, and that other communications devices, and means for establishing a communications link between the processing system 2000 and other devices, may be used.

The processing system 2000 may include one or more input devices 2034 such that a user may enter commands and information (e.g., a keyboard or mouse). Input devices 2034 may further include other types of input such as multimodal input, speech input, graffiti input, motion detection, facial recognition, physical fingerprinting, etc. These and other input devices may be coupled to the server by one or more interfaces 2038, such as a serial port interface, parallel port, universal serial bus (USB), etc. The processing system 2000 may further include a display 2022, such as a touch screen display.

The processing system 2000 may include a variety of tangible processor-readable storage media and intangible processor-readable communication signals including a virtual and/or cloud computing environment. Tangible processor-readable storage can be embodied by any available media that can be accessed by the processing system 2000, and includes both volatile and nonvolatile storage media, and removable and non-removable storage media. Tangible processor-readable storage media excludes intangible communications signals and includes volatile and nonvolatile, removable and non-removable, storage media implemented in any method or technology for storage of information such as processor-readable instructions, data structures, program modules, or other data. Tangible processor-readable storage media includes, but is not limited to, RAM, ROM, EEPROM, flash memory, or other memory technology, CDROM, digital versatile disks (DVD), or other optical disk storage, magnetic cassettes, magnetic tape, magnetic disk storage, or other magnetic storage devices, or any other tangible medium which can be used to store the desired information, and which can be accessed by the processing system 2000. In contrast to tangible processor-readable storage media, intangible processor-readable communication signals may embody computer-readable instructions, data structures, program modules, or other data resident in a modulated data signal, such as a carrier wave, or other signal transport mechanisms. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative, rather than a restrictive, sense, and all such modifications are intended to be included within the scope of present teachings.

The benefits, advantages, solutions to problems, and any element(s) that may cause any benefit, advantage, or solution to occur, or become more pronounced, are not to be construed as critical, required, or essential features, or elements of any or all the claims. The invention is defined, solely, by the appended claims, including any amendments made during the pendency of this application, and all equivalents of those claims as issued.

Moreover, in this document, relational terms, such as first and second, top and bottom, and the like, may be used solely to distinguish one entity or action from another entity or action without necessarily requiring or implying any actual such relationship, or order between such entities or actions. The terms “comprises,” “comprising,” “has,” “having,” “includes,” “including,” “contains,”, “containing,” or any other variation thereof, are intended to cover a non-exclusive inclusion, such that a process, method, article, or apparatus, that comprises, has, includes, contains a list of elements, does not include only those elements, but may include other elements, not expressly listed or inherent to such process, method, article, or apparatus. An element proceeded by “comprises . . . a,” “has . . . a,” “includes . . . a,” “contains . . . a,” does not, without more constraints, preclude the existence of additional identical elements in the process, method, article, or apparatus that comprises, has, includes, contains the element. The terms “a” and “an” are defined as one or more, unless explicitly stated otherwise herein. The terms “substantially”, “essentially”, “approximately”, “about,” or any other version thereof, are defined as being close to, as understood by one of ordinary skill in the art, and in one, non-limiting embodiment, the term is defined to be within 10%, in another embodiment within 5%, in another embodiment within 1%, and in another embodiment within 0.5%. The term “coupled,” as used herein, is defined as connected, although not necessarily directly, and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the method, and/or apparatus, described herein. Alternatively, some or all functions could be implemented by a state machine that has no stored program instructions, or in one or more application specific integrated circuits (ASICs), in which each function, or some combinations of certain functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), and a Flash memory. Further, it is expected that one of ordinary skill, notwithstanding possibly significant effort, and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method of offering exposure to a condition occurring outside a blockchain secured by automatic payment of digital asset funds on a decentralized blockchain price discovery platform, the method comprising:
observing a condition occurring outside of a blockchain;
determining a perceived value associated with the condition occurring outside of the blockchain; and
broadcasting a transaction to a network of the blockchain, the transaction, upon confirmation to the blockchain, adding a bi-directional quote to an aggregate of bi-directional quotes, upon which a single aggregate consensus value associated with the condition occurring outside the blockchain is based, the bi-directional quote having:
a spot value based on the perceived value;
a duration of time;
a backing value; and
an estimated premium cost.

2. The method of claim 1, wherein the decentralized blockchain price discovery platform determines, after confirmation of the transaction to the blockchain, an adjusted premium price of the bi-directional quote, the adjusted premium price being based at least in part on the estimated premium cost, on a direction of a potential consensus trade, and on a difference between the spot value of the bi-directional quote a current single aggregate consensus value.

3. The method of claim 1, further comprising:
receiving, from the decentralized blockchain price discovery platform, blockchain funds at a payment address on the blockchain representing a portion of the backing value upon expiration of a consensus trade filling at least a portion of the consensus trade, the portion of the backing value representing a value of the consensus trade at expiration.

4. The method of claim 1, wherein the condition occurring outside of the blockchain is a composite index of multiple market prices based on a published composite index weighting formula.

5. The method of claim 1, further comprising:
offering a trustless blockchain swap including a basket of one or more conditions occurring outside the blockchain to swap for exposure against at least one collateral digital asset.

6. A method of securing automatic future blockchain funds transfer on a decentralized price discovery platform on a blockchain based on price movement of a digital asset, the method comprising:
receiving, from the decentralized price discovery platform on the blockchain, a single aggregate consensus price of a market, the single aggregate consensus price being based on individual parameters of each of an aggregate of bi-directional quotes, the individual parameters including at least a spot price, a duration, an estimated premium price, and a blockchain digital asset backing value attached thereto;
determining an observed price of the market outside the blockchain;
determining a direction of price movement based on a comparison of the single aggregate consensus price to the observed price to yield a determined direction of price movement; and
broadcasting a transaction to a network of the blockchain, the transaction filling a quantity of the aggregate of the bi-directional quotes in the determined direction of price movement to yield, when confirmed on the blockchain, a filled quantity of a consensus trade, the consensus trade having an adjusted premium cost based on at least the estimated premium price and a difference between spot prices of the filled quantity and a single aggregate consensus price at a time of confirmation of the consensus trade, wherein the transaction includes transfer of a token on the blockchain paying the adjusted premium cost of the filled quantity.

7. The method of claim 6, further including:
receiving a settlement of the consensus trade at a payment address on the blockchain, the settlement being paid by the decentralized price discovery platform with a portion of the digital asset backing value, where an amount of the settlement is determined based on a comparison of a current single aggregate consensus price at a time of expiration of the filled quantity to the single aggregate consensus price at the time of confirmation of the consensus trade.

8. The method of claim 6, wherein the market is limited to a geographically regional area.

9. A computer program product comprising a non-transitory computer readable medium which comprises instructions, that when executed by one or more validators of a blockchain network, cause the validators of the blockchain network to:
accept, from a market maker, a request to place a bi-directional quote into an aggregate of on-chain bi-directional quotes, each of the bi-directional quotes in the aggregate including a spot price, a duration, an estimated premium price, and a backing value, and the aggregate further having a total quantity;
determine an aggregate consensus value based on the spot price of each of the bi-directional quotes in the aggregate, weighted according to the estimated premium, and backing of each of the bi-directional quotes in the aggregate;
determine, upon each change of the aggregate, at least a call adjusted premium, and a put adjusted premium, of each bi-directional quote in the aggregate, the call adjusted premium and the put adjusted premium being based on the estimated premium and a difference between the spot price of each bi-directional quote in the aggregate and an aggregate consensus value at the time of a completion of the operation that determines an aggregate consensus value; and
accepts, from a trader, via a transaction confirmed on the blockchain, a request to fill a purchased quantity of the aggregate of bi-directional quotes to yield a consensus trade, thus removing the purchased quantity from the total quantity of the aggregate of bi-directional quotes, the consensus trade having a price of the sum of the adjusted premiums of the bi-directional quotes of the purchased quantity.

10. The computer program product of claim 9, wherein the non-transitory computer readable medium which comprises instructions, that when executed by one or more validators of a blockchain network, further causes the validators of the blockchain network to:
determine whether a quote smart contract from a pool of quote smart contracts satisfies an availability condition;
store the bi-directional quote accepted from the market maker into the quote smart contract if the availability condition is satisfied; and
create a new quote smart contract in the pool of quote smart contracts if the availability condition is not satisfied.

11. The computer program product of claim 9, wherein the non-transitory computer readable medium which comprises instructions, that when executed by one or more validators of a blockchain network, further causes the validators of the blockchain network to:
accept, from the market maker, a deposit of tokens, via a transaction confirmed on the blockchain, as the backing value of the bi-directional quote.

12. The computer program product of claim 9, wherein the non-transitory computer readable medium which comprises instructions, that when executed by one or more validators of a blockchain network, further causes the validators of the blockchain network to:
create a trade history on the blockchain accessible to any party possessing a copy of the blockchain, the trade history including parameters of filled option quotes.

13. The computer program product of claim 9, wherein the non-transitory computer readable medium which comprises instructions, that when executed by one or more validators of a blockchain network, further causes the validators of the blockchain network to:
accept, from the market maker, a subscription fee for placing option quotes on the option-based blockchain oracle marketplace.

14. The computer program product of claim 9, wherein the one or more transactions, when executed according to the consensus rules of the blockchain, further:
matches a market trade order with one or more quotes having a best actual premium cost according to a circular linked list.

15. A decentralized price discovery platform apparatus comprising:
a plurality of blockchain validators maintaining updates to a blockchain according to consensus rules;
a non-transitory memory shared by the plurality of blockchain validators storing executable instructions, the executable instructions executable according to the consensus rules and including:
a bi-directional quote interface for recording bi-directional quotes into an aggregate of on-chain bi-directional quotes, each of the bi-directional quotes in the aggregate including a spot price, a duration, an estimated premium price, and a backing value;
an aggregate consensus component for
(a) determining a single aggregate consensus price based on the spot price of each of the bi-directional quotes in the aggregate, weighted according to the estimated premium and according to the backing value of each bi-directional quote in the aggregate, and
(b) recording the single aggregate consensus value to the blockchain, and
(c) determining at least a call adjusted premium and a put adjusted premium of each bi-directional quote in the aggregate, the call adjusted premium and the put adjusted premium being based on the estimated premium and a difference between the spot price of each bi-directional quote and the single aggregate consensus value of each bi-directional quote in the aggregate of bi-directional quotes, and
(d) recording the call adjusted premium and the put adjusted premium of each bi-directional quote in the aggregate of bi-directional quotes to the blockchain, and
(e) repeating steps (a) and (b) for upon each change to the aggregate of on-chain bi-directional quotes
a trading component for accepting, from a trader, a request to fill a purchased quantity of the aggregate of bi-directional quotes to yield a consensus trade, thus removing the purchased quantity from a total quantity of the aggregate of bi-directional quotes, the consensus trade having a price based on the adjusted premiums of the purchased quantity, and
a settlement component for determining the value of the consensus trade at expiration and causing a settlement transaction to be confirmed on the blockchain, the settlement transaction apportioning the backing value of the purchased quantity to the trader and the market maker according to a difference between the single consensus value at a time the consensus trade was made compared to a single consensus value at expiration.

16. The decentralized price discovery platform apparatus of claim 15, wherein the aggregate of bi-directional quotes includes bi-directional quotes confirmed on one or more independent price discovery platforms on separate blockchains that are visible to the plurality of blockchain validators via an inter-blockchain communications protocol and not by confirming transactions to the blockchain, the independent price discovery platforms sharing a same backing value token with the price discovery platform.

17. The decentralized price discovery platform apparatus of claim 15, wherein the consensus rules of the blockchain include a halt point after which no additional transactions are confirmed by the validators.

18. The decentralized price discovery platform apparatus of claim 17, wherein the non-transitory memory shared by the plurality of blockchain validators storing executable instructions, the executable instructions executable according to the consensus rules further includes a winding down component for preventing the trading component from accepting a request to fill bi-directional quotes that would expire after the halt point.

19. The decentralized price discovery platform apparatus of claim 15, wherein the non-transitory memory shared by the plurality of blockchain validators storing executable instructions, the executable instructions executable according to the consensus rules further includes an oracle component that automatically writes the single aggregate consensus value to the blockchain such that the single aggregate consensus value is readable via inter-blockchain communications by independent blockchains and not by confirming a transaction on any of the independent blockchains.

20. The decentralized price discovery platform apparatus of claim 15, wherein the non-transitory computer readable medium which comprises instructions, that when executed by one or more validators of a blockchain network, further causes the validators of the blockchain network to restart the decentralized price discovery platform on another blockchain with marketplace parameters received from an operator of the decentralized price discovery platform.
